(19) United States
(12) Patent Application Publication
(10) Pub. No.: US 2025/0383555 A1
(43) Pub. Date: Dec. 18, 2025

(54) CAMERA AND ELECTRONIC DEVICE INCLUDING SAME

(71) Applicant: SAMSUNG ELECTRONICS CO., LTD., Suwon--si (KR)

(72) Inventor: Youngbok YU, Suwon-si (KR)

(73) Assignee: SAMSUNG ELECTRONICS CO., LTD., Suwon-si (KR)

(21) Appl. No.: 19/285,428

(22) Filed: Jul. 30, 2025

Related U.S. Application Data
(63) Continuation of application No. PCT/KR2025/008354, filed on Jun. 17, 2025.

(30) Foreign Application Priority Data
Jun. 18, 2024 (KR) 10-2024-0079210
Dec. 9, 2024 (KR) 10-2024-0181981

(51) Int. Cl. G02B 27/64; G03B 5/00; G03B 13/36; H01F 7/08

(52) U.S. Cl. CPC G02B 27/646; G03B 5/00; G03B 13/36; H01F 7/081; G03B 2205/0007; G03B 2205/0069

(57) ABSTRACT

There is provided an electronic device and camera thereof including: an optical system including an optical axis; an image sensor partially aligned with the optical axis; a base housing partially surrounding the image sensor; an autofocus (AF) housing partially arranged in the base housing and movable along the optical axis; a coil circuit board partially disposed on a bottom of the AF housing and including first and second coils with a magnetic axis along the optical axis; and an optical image stabilization (OIS) housing in which the optical system is disposed and at least partially received in the AF housing, the OIS housing includes a first and second magnets facing the first and second coils, and movable in a direction perpendicular to the optical axis and a second direction, perpendicular to the optical axis and the direction, by the first and second coils and the first and second magnets.

### CROSS-REFERENCE TO RELATED APPLICATIONS

This application is a continuation of International Application No. PCT/KR2025/008354, filed on Jun. 17, 2025, which is based on and claims priority both to Korean Patent Application No. 10-2024-0079210, filed on Jun. 18, 2024, in the Korean Intellectual Property Office, and to Korean Patent Application No. 10-2024-0181981, filed on Dec. 9, 2024, in the Korean Intellectual Property Office, the disclosures of which are incorporated by reference herein in their entireties.

### BACKGROUND

### 1. Field

Various embodiments of the disclosure relate to an imaging device of an electronic device and, more particularly, to a camera and an electronic device including the same.

### 2. Description of Related Art

An electronic device may include an imaging device (e.g., a camera) for capturing a still image and/or video. The camera may include an optical system (optics) (e.g., a lens, a reflector, a prism, and/or a polarizer) which collects light to form an image, and an image sensor which converts an image formed by the optical system into an electrical signal.

The size of the optical system of the camera may constrain the performance of the camera. For example, the size of the optical system of the camera of the electronic device may be limited due to portability and internal space constraints. Therefore, a numerical aperture of the optical system of the camera of the electronic device may be limited, which may cause an increased shutter opening time and excessive image blur when capturing an image in a low-light environment.

In order to at least partially compensate for the image blur described above, the camera of the electronic device may include an image stabilization system which compensates for the movement of the camera. The image stabilization system may include an electronic image stabilization (EIS) system which electronically compensates for image data acquired from a sensor, and an optical image stabilization (OIS) system which optically stabilizes an image itself formed on an imaging surface. The optical image stabilization system may include a sensor-shift optical image stabilization (sensor-shift OIS) system which moves a camera sensor, and a lens-shift optical image stabilization (lens-shift OIS) system which moves the optical system.

The above-described information may be provided as related art for the purpose of facilitating the understanding of the disclosure. No claim or determination is made as to whether any of the foregoing is applicable as prior art with respect to this disclosure.

### SUMMARY

There is provided an electronic device including a camera, the camera including: an optical system including an optical axis; an image sensor that is at least partially aligned with the optical axis of the optical system; a base housing which is at least partially surrounding the image sensor; an autofocus (AF) housing at least partially arranged in the base housing and configured to be movable along a direction of the optical axis; a coil circuit board at least partially disposed on a bottom surface of the AF housing and including a first coil and a second coil oriented with a magnetic axis facing a direction identical to that of the optical axis; and an optical image stabilization (OIS) housing in which the optical system is disposed and which is at least partially received in the AF housing, wherein the OIS housing includes a first magnet, facing the first coil, and a second magnet, facing the second coil, and is configured to be movable in a first direction, substantially perpendicular to the optical axis, and a second direction, substantially perpendicular to both of the optical axis and the first direction, by the first coil, the second coil, the first magnet, and the second magnet.

The first magnet and the second magnet may be arranged on a first surface of the OIS housing substantially parallel to the bottom surface of the AF housing, and the OIS housing may be at least partially disposed within the AF housing and a distance between the bottom surface of the AF housing and the first surface is substantially constant when moved in any of the first direction and the second direction.

The first magnet may be a single-sided two-pole magnet.

The coil circuit board may include a first portion, disposed on the bottom surface of the AF housing, and a second portion substantially perpendicular to the first portion, and wherein the first coil may be disposed in the first portion, and the second coil may be disposed in the second portion.

The camera further may include a guide member disposed within the AF housing and configured both to limit a rotational movement of the OIS housing, around the direction of the optical axis as a rotation axis, and to allow a movement of the OIS housing in the first direction and the second direction.

The second coil may include a (2-1)th coil and a (2-2)th coil which are arranged substantially parallel to each other.

The coil circuit board may include: a first fixing part fixed to the AF housing; a second fixing part fixed to the base housing; and a flexible part positioned between the first fixing part and the second fixing part and including a flexibility greater than that of the first fixing part and the second fixing part.

A length of the flexible part may be longer than a distance between an area of the AF housing to which the first fixing part is fixed and an area of the base housing to which the second fixing part is fixed.

The AF housing may be configured to receive the flexible part in the AF housing while at least a part of the flexible part is bent.

At least a partial area of the coil circuit board may be positioned between an outer surface of the OIS housing and an inner surface of the AF housing, and the OIS housing may include a stopper protruded in at least one of the first direction or the second direction from the outer surface of the OIS housing, and wherein a length of the stopper protruded from the outer surface of the OIS housing may be equal to or greater than a width of the coil circuit board positioned between the outer surface of the OIS housing and the inner surface of the AF housing.

The camera further may include: a third coil disposed on an inner surface of the base housing; and a third magnet disposed in the AF housing, facing the third coil, and including a magnetic pole applying a magnetic force in the direction of the optical axis with respect to the third coil.

The camera further may include: a third magnet disposed on an inner surface of the base housing; and a third coil disposed in the AF housing and facing the third magnet, and the third magnet may include a magnetic pole applying a magnetic force in the direction of the optical axis with respect to the third coil, and the coil circuit board may include a third portion in which the third coil is disposed.

There is provided a camera including: an optical system including an optical axis; an image sensor that is at least partially aligned with the optical axis of the optical system; a base housing which is at least partially surrounding the image sensor; an autofocus (AF) housing at least partially arranged in the base housing and configured to be movable along a direction of the optical axis; a coil circuit board at least partially disposed on a bottom surface of the AF housing and including a first coil and a second coil oriented with a magnetic axis facing a direction identical to that of the optical axis; and an optical image stabilization (OIS) housing in which the optical system is disposed and which is at least partially received in the AF housing, wherein the OIS housing includes a first magnet facing the first coil and a second magnet facing the second coil, and is configured to be movable in a first direction, substantially perpendicular to the optical axis, and a second direction, substantially perpendicular to both of the optical axis and the first direction, by the first coil, the second coil, the first magnet, and the second magnet.

The first magnet and the second magnet may be arranged on a first surface of the OIS housing substantially parallel to the bottom surface of the AF housing, and the OIS housing may be at least partially disposed within the AF housing and a distance between the bottom surface of the AF housing and the first surface is substantially constant when moved in any of the first direction and the second direction.

The coil circuit board may include a first portion, disposed on the bottom surface of the AF housing, and a second portion substantially perpendicular to the first portion, and the first coil may be disposed in the first portion, and the second coil may be disposed in the second portion.

The camera may include a guide member disposed within the AF housing and configured both to limit a rotational movement of the OIS housing, around the direction of the optical axis as a rotation axis, and to allow a movement of the OIS housing in the first direction and the second direction.

The second coil may include a (2-1)th coil and a (2-2)th coil which are arranged substantially parallel to each other.

The coil circuit board may include: a first fixing part fixed to the AF housing; a second fixing part fixed to the base housing; and a flexible part positioned between the first fixing part and the second fixing part and including a flexibility greater than that of the first fixing part and the second fixing part, and a length of the flexible part is longer than a distance between an area of the AF housing to which the first fixing part is fixed and an area of the base housing to which the second fixing part is fixed.

At least a partial area of the coil circuit board may be positioned between an outer surface of the OIS housing and an inner surface of the AF housing, the OIS housing may include a stopper protruded in at least one of the first direction or the second direction from the outer surface of the OIS housing, and a length of the stopper protruded from the outer surface of the OIS housing may be equal to or greater than a width of the coil circuit board positioned between the outer surface of the OIS housing and the inner surface of the AF housing.

The camera may include a third coil disposed on an inner surface of the base housing; and a third magnet disposed in the AF housing, facing the third coil, and including a magnetic pole applying a magnetic force in the direction of the optical axis with respect to the third coil.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1A is a block diagram of an electronic device in a network environment according to various embodiments;

FIG. 1B is a block diagram of an exemplary electronic device capable of performing operations described herein;

FIG. 2A is a perspective view of a front surface of an electronic device according to various embodiments of the disclosure;

FIG. 2B is a perspective view of a rear surface of an electronic device according to various embodiments of the disclosure;

FIG. 3 is a block diagram illustrating a configuration of a camera module included in an electronic device according to one or more embodiments;

FIG. 4A is a perspective view illustrating a camera of an electronic device according to various embodiments;

FIG. 4B is an exploded perspective view illustrating a camera of an electronic device according to various embodiments;

FIG. 5A is an exploded perspective view illustrating an AF housing and an OIS housing of an electronic device according to various embodiments;

FIG. 5B is an exploded perspective view illustrating an AF housing and an OIS housing of an electronic device according to various embodiments;

FIG. 5C is a plan view illustrating an AF housing of an electronic device according to various embodiments;

FIG. 5D is a plan view illustrating a coil circuit board of an electronic device according to various embodiments;

FIG. 6A is a schematic view illustrating a coil and a magnet of a camera according to various embodiments;

FIG. 6B is a graph illustrating the strength of a magnetic field with respect to the amount of movement of a magnet of a camera according to various embodiments;

FIG. 6C is a schematic view illustrating a coil and a magnet of a camera according to a comparative example;

FIG. 6D is a graph illustrating the strength of a magnetic field with respect to the amount of movement of a magnet of a camera according to a comparative example;

FIG. 7A is an exploded perspective view illustrating a camera according to various embodiments;

FIG. 7B is an exploded perspective view illustrating a camera according to various embodiments;

FIG. 7C is a schematic view illustrating a torque offsetting operation of a camera according to various embodiments;

FIG. 8 is a cross-sectional view of a camera according to various embodiments;

FIG. 9A is a cross-sectional view of a camera according to various embodiments;

FIG. 9B is a cross-sectional view illustrating an AF operation of a camera according to various embodiments;

FIG. 10A is a perspective view illustrating an AF housing according to various embodiments;

FIG. 10B is a plan view illustrating a coil circuit board according to various embodiments;

FIG. 10C is a cross-sectional view illustrating a camera according to various embodiments;

FIG. 10D is a plan view illustrating a coil circuit board according to various embodiments;

FIG. 11A is an exploded perspective view illustrating a camera according to various embodiments;

FIG. 11B is a plan view illustrating a base housing and an AF housing of a camera according to various embodiments; and

FIG. 11C is a plan view illustrating a coil circuit board and a fixed circuit board according to various embodiments.

### DETAILED DESCRIPTION

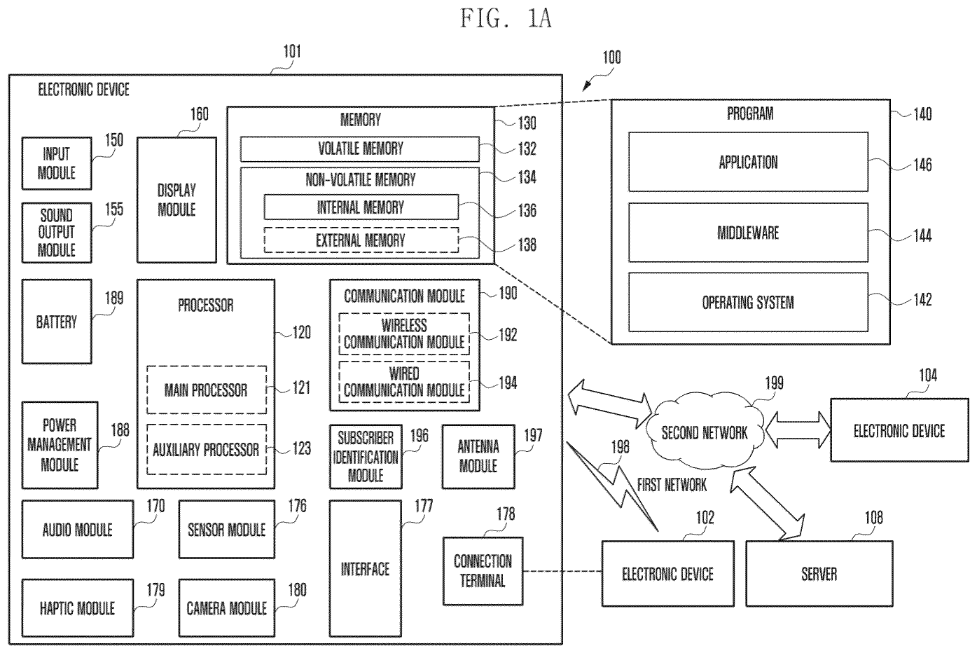

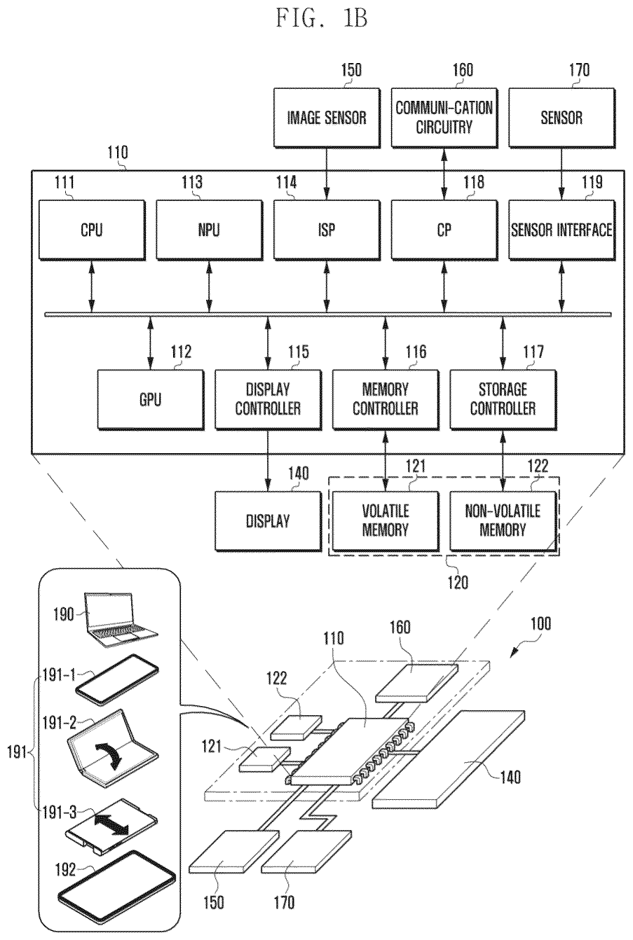

FIG. 1a is a block diagram illustrating an electronic device 1 in a network environment 00 according to various embodiments. Referring to FIG. 1a, the electronic device 1 in the network environment 00 may communicate with an electronic device 02 via a first network 98 (e.g., a short-range wireless communication network), or at least one of an electronic device 04 or a server 08 via a second network 99 (e.g., a long-range wireless communication network). According to an embodiment, the electronic device 1 may communicate with the electronic device 04 via the server 08. According to an embodiment, the electronic device 1 may include a processor 20, memory 30, an input module 50, a sound output module 55, a display module 60, an audio module 70, a sensor module 76, an interface 77, a connecting terminal 78, a haptic module 79, a camera module 80, a power management module 88, a battery 89, a communication module 90, a subscriber identification module (SIM) 96, or an antenna module 97. In some embodiments, at least one of the components (e.g., the connecting terminal 78) may be omitted from the electronic device 1, or one or more other components may be added in the electronic device 1. In some embodiments, some of the components (e.g., the sensor module 76, the camera module 80, or the antenna module 97) may be implemented as a single component (e.g., the display module 60).

The processor 20 may execute, for example, software (e.g., a program 40) to control at least one other component (e.g., a hardware or software component) of the electronic device 1 coupled with the processor 20, and may perform various data processing or computation. According to one embodiment, as at least part of the data processing or computation, the processor 20 may store a command or data received from another component (e.g., the sensor module 76 or the communication module 90) in volatile memory 32, process the command or the data stored in the volatile memory 32, and store resulting data in non-volatile memory 34. According to an embodiment, the processor 20 may include a main processor 21 (e.g., a central processing unit (CPU) or an application processor (AP)), or an auxiliary processor 23 (e.g., a graphics processing unit (GPU), a neural processing unit (NPU), an image signal processor (ISP), a sensor hub processor, or a communication processor (CP)) that is operable independently from, or in conjunction with, the main processor 21. For example, when the electronic device 1 includes the main processor 21 and the auxiliary processor 23, the auxiliary processor 23 may be adapted to consume less power than the main processor 21, or to be specific to a specified function. The auxiliary processor 23 may be implemented as separate from, or as part of the main processor 21.

The auxiliary processor 23 may control at least some of functions or states related to at least one component (e.g., the display module 60, the sensor module 76, or the communication module 90) among the components of the electronic device 1, instead of the main processor 21 while the main processor 21 is in an inactive (e.g., sleep) state, or together with the main processor 21 while the main processor 21 is in an active state (e.g., executing an application). According to an embodiment, the auxiliary processor 23 (e.g., an image signal processor or a communication processor) may be implemented as part of another component (e.g., the camera module 80 or the communication module 90) functionally related to the auxiliary processor 23. According to an embodiment, the auxiliary processor 23 (e.g., the neural processing unit) may include a hardware structure specified for artificial intelligence model processing. An artificial intelligence model may be generated by machine learning. Such learning may be performed, e.g., by the electronic device 1 where the artificial intelligence is performed or via a separate server (e.g., the server 08). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 30 may store various data used by at least one component (e.g., the processor 20 or the sensor module 76) of the electronic device 1. The various data may include, for example, software (e.g., the program 40) and input data or output data for a command related thererto. The memory 30 may include the volatile memory 32 or the non-volatile memory 34.

The program 40 may be stored in the memory 30 as software, and may include, for example, an operating system (OS) 42, middleware 44, or an application 46.

The input module 50 may receive a command or data to be used by another component (e.g., the processor 20) of the electronic device 1, from the outside (e.g., a user) of the electronic device 1. The input module 50 may include, for example, a microphone, a mouse, a keyboard, a key (e.g., a button), or a digital pen (e.g., a stylus pen).

The sound output module 55 may output sound signals to the outside of the electronic device 1. The sound output module 55 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 60 may visually provide information to the outside (e.g., a user) of the electronic device 1. The display module 60 may include, for example, a display, a hologram device, or a projector and control circuitry to control a corresponding one of the display, hologram device, and projector. According to an embodiment, the display module 60 may include a touch sensor adapted to detect a touch, or a pressure sensor adapted to measure the intensity of force incurred by the touch.

The audio module 70 may convert a sound into an electrical signal and vice versa. According to an embodiment, the audio module 70 may obtain the sound via the input module 50, or output the sound via the sound output module 55 or a headphone of an external electronic device (e.g., an electronic device 02) directly (e.g., wiredly) or wirelessly coupled with the electronic device 1.

The sensor module 76 may detect an operational state (e.g., power or temperature) of the electronic device 1 or an environmental state (e.g., a state of a user) external to the electronic device 1, and then generate an electrical signal or data value corresponding to the detected state. According to an embodiment, the sensor module 76 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 77 may support one or more specified protocols to be used for the electronic device 1 to be coupled with the external electronic device (e.g., the electronic device 02) directly (e.g., wiredly) or wirelessly. According to an embodiment, the interface 77 may include, for example, a high definition multimedia interface (HDMI), a universal serial bus (USB) interface, a secure digital (SD) card interface, or an audio interface.

A connecting terminal 78 may include a connector via which the electronic device 1 may be physically connected with the external electronic device (e.g., the electronic device 02). According to an embodiment, the connecting terminal 78 may include, for example, a HDMI connector, a USB connector, a SD card connector, or an audio connector (e.g., a headphone connector).

The haptic module 79 may convert an electrical signal into a mechanical stimulus (e.g., a vibration or a movement) or electrical stimulus which may be recognized by a user via his tactile sensation or kinesthetic sensation. According to an embodiment, the haptic module 79 may include, for example, a motor, a piezoelectric element, or an electric stimulator.

The camera module 80 may capture a still image or moving images. According to an embodiment, the camera module 80 may include one or more lenses, image sensors, image signal processors, or flashes.

The power management module 88 may manage power supplied to the electronic device 1. According to one embodiment, the power management module 88 may be implemented as at least part of, for example, a power management integrated circuit (PMIC).

The battery 89 may supply power to at least one component of the electronic device 1. According to an embodiment, the battery 89 may include, for example, a primary cell which is not rechargeable, a secondary cell which is rechargeable, or a fuel cell.

The communication module 90 may support establishing a direct (e.g., wired) communication channel or a wireless communication channel between the electronic device 1 and the external electronic device (e.g., the electronic device 02, the electronic device 04, or the server 08) and performing communication via the established communication channel. The communication module 90 may include one or more communication processors that are operable independently from the processor 20 (e.g., the application processor (AP)) and supports a direct (e.g., wired) communication or a wireless communication. According to an embodiment, the communication module 90 may include a wireless communication module 92 (e.g., a cellular communication module, a short-range wireless communication module, or a global navigation satellite system (GNSS) communication module) or a wired communication module 94 (e.g., a local area network (LAN) communication module or a power line communication (PLC) module). A corresponding one of these communication modules may communicate with the external electronic device via the first network 98 (e.g., a short-range communication network, such as Bluetooth™, wireless-fidelity (Wi-Fi) direct, or infrared data association (IrDA)) or the second network 99 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 92 may identify and authenticate the electronic device 1 in a communication network, such as the first network 98 or the second network 99, using subscriber information (e.g., international mobile subscriber identity (IMSI)) stored in the subscriber identification module 96.

The wireless communication module 92 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 92 may support a high-frequency band (e.g., the mmWave band) to achieve, e.g., a high data transmission rate. The wireless communication module 92 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 92 may support various requirements specified in the electronic device 1, an external electronic device (e.g., the electronic device 04), or a network system (e.g., the second network 99). According to an embodiment, the wireless communication module 92 may support a peak data rate (e.g., 20 Gbps or more) for implementing eMBB, loss coverage (e.g., 64 dB or less) for implementing mMTC, or U-plane latency (e.g., 0.5 ms or less for each of downlink (DL) and uplink (UL), or a round trip of ms or less) for implementing URLLC.

The antenna module 97 may transmit or receive a signal or power to or from the outside (e.g., the external electronic device) of the electronic device 1. According to an embodiment, the antenna module 97 may include an antenna including a radiating element composed of a conductive material or a conductive pattern formed in or on a substrate (e.g., a printed circuit board (PCB)). According to an embodiment, the antenna module 97 may include a plurality of antennas (e.g., array antennas). In such a case, at least one antenna appropriate for a communication scheme used in the communication network, such as the first network 98 or the second network 99, may be selected, for example, by the communication module 90 (e.g., the wireless communication module 92) from the plurality of antennas. The signal or the power may then be transmitted or received between the communication module 90 and the external electronic device via the selected at least one antenna. According to an embodiment, another component (e.g., a radio frequency integrated circuit (RFIC)) other than the radiating element may be additionally formed as part of the antenna module 97.

According to various embodiments, the antenna module 97 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1 and the external electronic device 04 via the server 08 coupled with the second network 99. Each of the electronic devices 02 or 04 may be a device of a same type as, or a different type, from the electronic device 1. According to an embodiment, all or some of operations to be executed at the electronic device 1 may be executed at one or more of the external electronic devices 02, 04, or 08. For example, if the electronic device 1 should perform a function or a service automatically, or in response to a request from a user or another device, the electronic device 1, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1. The electronic device 1 may provide the outcome, with or without further processing of the outcome, as at least part of a reply to the request. To that end, a cloud computing, distributed computing, mobile edge computing (MEC), or client-server computing technology may be used, for example. The electronic device 1 may provide ultra low-latency services using, e.g., distributed computing or mobile edge computing. In another embodiment, the external electronic device 04 may include an internet-of-things (IoT) device. The server 08 may be an intelligent server using machine learning and/or a neural network. According to an embodiment, the external electronic device 04 or the server 08 may be included in the second network 99. The electronic device 1 may be applied to intelligent services (e.g., smart home, smart city, smart car, or healthcare) based on 5G communication technology or IoT-related technology.

FIG. 1B illustrates a block diagram of an exemplary electronic device 100 capable of performing the operations described herein.

Referring to FIG. 1B, the electronic device 100 may be one of various types of electronic devices, such as a notebook computer 190, smartphones 191 having various form factors (e.g., a bar-type smartphone 191-1, a foldable smartphone 191-2, or a slidable (or rollable) smartphone 191-3), a tablet PC 192, a cellular telephone (not shown), and any other similar computing devices (not shown). The components illustrated in FIG. 1B, the relationships thereof, and the functions thereof are merely for illustration, and are not intended to limit the implementations described or claimed in the disclosure thereto. The electronic device 100 may be referred to as a mobile device, a user equipment, a multifunctional device, a portable device, or a server.

The electronic device 100 may comprise various components including at least one processor 110 (hereinafter, the processor 110), at least one memory 120 (hereinafter, the memory 120), at least one display 140 (hereinafter, the display 140), at least one image sensor 150 (hereinafter, the image sensor 150), at least one communication circuitry 160 (hereinafter, the communication circuitry 160), and/or at least one sensor 170 (hereinafter, the sensor 170). The aforementioned components are merely of an example. For example, the electronic device 100 may comprise other components (e.g., a power management integrated circuitry (PMIC), an audio processing circuitry, an antenna, a rechargeable battery, or an input/output interface). For example, some components may be omitted from the electronic device (100). For example, some components may be integrated into one component.

The processor 110 may be implemented as one or more integrated circuit (or circuitry) (IC) chips and may perform various data processing. The processor 110 may include at least one electrical circuitry and may process instructions (or program, data, and so on) stored in the memory 120 individually or collectively in a distributed manner. The processor 110 may include a processor assembly that includes one or more processing circuitries. The processor may include any processing circuitry that may be operative for controlling operations and performance of one or more components (e.g., the memory 120, a display 140, the image sensor 150, the communication circuitry 160, and/or the sensor 170) of the electronic device. For example, the processor 110 (e.g., an application processor (AP)) may be implemented as a system on chip (SoC) (e.g., one chip or chipset). For example, the processor 110 may be implemented as a plurality of cores (or at least one core circuitry), a plurality of chips, or a plurality of chipsets. For example, the processor 110 may comprise one or more processing circuitry. For example, the processor 110 may comprise one or more processing circuitry which are individually and/or collectively configured to perform various functions of the present disclosure. As a non-limiting example, at least a portion of the processor 110 may be included in a first chip of the electronic device 100 and at least another portion of the processor 110 may be included in a second chip of the electronic device 100 different from the first chip of the electronic device 100.

For example, the processor 110 may comprise a central processing unit (CPU) 111, a graphics processing unit (GPU) 112, a neural processing unit (NPU) 113, an image signal processor (ISP) 114, a display controller 115, a memory controller 116, a storage controller 117, a communication processor (CP) 118, and/or a sensor interface 119. These components of the processor 110 are merely of an example. For example, the processor 110 may further comprise other components. For example, some components of the processor 110 may be omitted from the processor 110. For example, some components of the processor 110 may be included as separate components of the electronic device 100 outside the processor 110. For example, some components of the processor 110 (e.g., the memory controller 116) may be included in other components of the electronic device 100 (e.g., at least a portion of the memory 120, an interface (e.g., usable for connecting to at least one component of the electronic device 100), the display 140, and/or the image sensor 150).

The processor 110 may cause other components of the electronic device 100 to perform various operations by executing instructions stored in the memory 120. The CPU 111 (or a central processing circuitry) may be configured to control the components of the processor 110 based on execution of instructions stored in the memory 120 (e.g., the volatile memory 121 and/or the non-volatile memory 122). The GPU 112 (or a graphic processing circuitry) may be configured to execute parallel computations (e.g., rendering). The NPU 113 (or a neural processing circuitry, or an artificial intelligence (AI) chip) may be configured to execute operations (e.g., convolution computations) for an artificial intelligence model. The ISP 114 (or an image signal processing circuitry) may be configured to process a raw image obtained from the image sensor 150 in a format suitable for a component in the electronic device 100 or a component of the processor 110. The display controller 115 (or a display control circuitry, or a display processing unit (DPU)) may be configured to process an image obtained from the CPU 111, the GPU 112, the ISP 114, or the memory 120 (e.g., the volatile memory 121) in a format suitable for the display 140. The memory controller 116 (or a memory control circuitry) may be configured to control reading data from the volatile memory 121 and writing data to the volatile memory 121. The storage controller 117 (or a storage control circuitry) may be configured to control reading data from the non-volatile memory 122 and writing data to the non-volatile memory 122. The CP 118 (or a communication processing circuitry) may be configured to process data obtained from a component of the processor 110 in a format suitable for transmission to another electronic device via the communication circuitry 160, or to process data obtained from another electronic device via the communication circuitry 160 in a format suitable for processing of the component of the processor 110. For example, the communication circuitry 160 may comprise one or more communication circuitry. The sensor interface 119 (or a sensing data processing circuitry, a sensor hub) may be configured to process data on a state of the electronic device 100 and/or a state around the electronic device 100, obtained through the sensor 170, in a format suitable for a component of the processor 110.

The memory 120 may comprise one or more storage mediums (or one or more storage devices). For example, the memory 120 may include a memory assembly that includes one or more storage mediums. For example, the one or more storage mediums may comprise a permanent memory (e.g., the non-volatile memory 122) such as a hard drive, a flash memory, a read-only memory (ROM), a semi-permanent memory (e.g., the volatile memory 121) such as a random access memory (RAM), a storage (or a storage assembly) of any other suitable type, or any combination thereof. The memory 120 may comprise a cache memory which is a memory of one or more different types used to store data for performing a function or feature of the electronic device 100 at least temporarily. As a non-limiting example, the cache memory may be included in the processor 110. The memory 120 may be fixedly embedded within the electronic device 100, or may be incorporated onto one or more suitable types of components that may be repeatedly inserted into the electronic device 100, and removed from the electronic device 100 (e.g., a subscriber identity module (SIM) card, and/or a secure digital (SD) card).

For example, the memory 120 may store one or more software applications such as an operating system (or a system) software application, a firmware software application, a driver software application, a plug-in (e.g., add-in, add-on, and/or applet) software application, and/or any other suitable software application. For example, the one or more software applications may include instructions executable by the processor 110. For example, the memory 120 may store instructions callable by an application programming interface (API). For example, the memory 120 may store instructions in a library.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to.” “connected with.” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program #40) including one or more instructions that are stored in a storage medium (e.g., internal memory #36 or external memory #38) that is readable by a machine (e.g., the electronic device #01). For example, a processor (e.g., the processor #20) of the machine (e.g., the electronic device #01) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

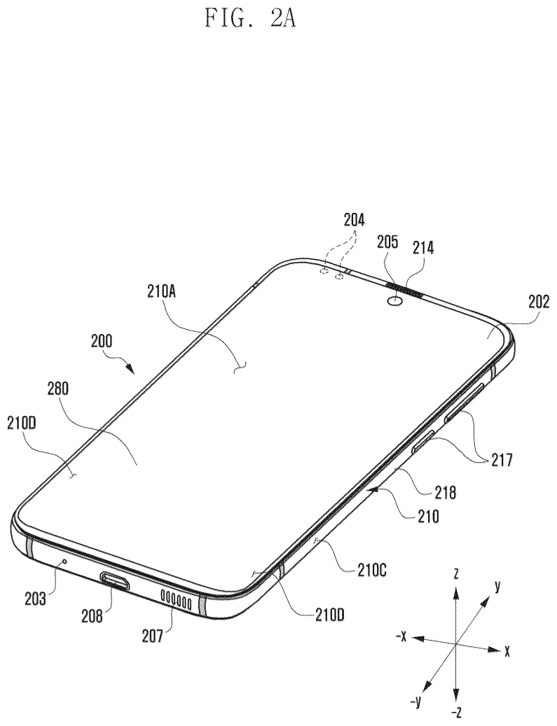

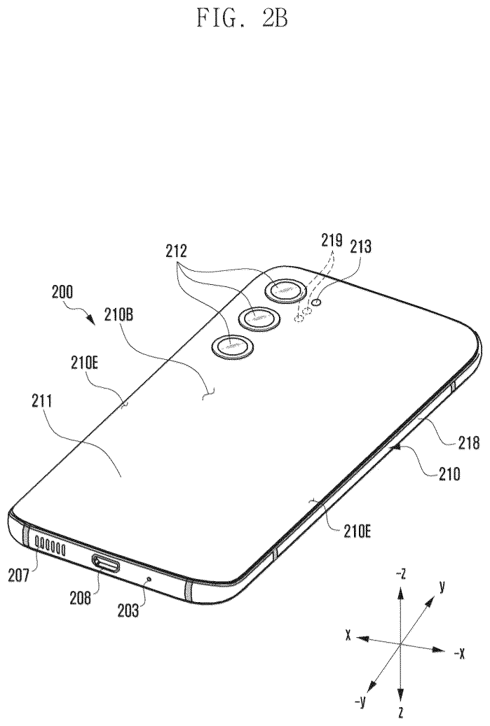

In the following description, the orthogonal coordinate system (x-y-z coordinate system) of the drawings may be referenced to explain various directions. It should be understood that the directions on the orthogonal coordinate system of the drawings referenced in the following description are exemplary, and descriptions such as ‘first direction’ and ‘second direction’ of the embodiments of the present disclosure may include not only specific directions on the drawings but also other directions. In addition, a term such as ‘x-axis direction’ in the following description may include both directions of the corresponding coordinate axis, for example, the +x direction and the −x direction. FIG. 2A is a perspective view of a front surface of an electronic device according to various embodiments of the disclosure. FIG. 2B is a perspective view of a rear surface of the electronic device of FIG. 2A according to various embodiments of the disclosure.

An electronic device 200 of FIG. 2A and FIG. 2B may be at least partially similar to the electronic device 1 of FIG. 1A and the electronic device 100 of FIG. 1B, or may include various embodiments of the electronic device.

Referring to FIG. 2A and FIG. 2B, the electronic device 200 according to one or more embodiments may include a housing 210 including a first surface 210A (which may be a front surface), a second surface 210B (which may be a rear surface), and a lateral surface 210C surrounding a space between the first surface 210A and the second surface 210B. In an embodiment, the housing 210 may refer to a structure which forms a part of the first surface 210A, the second surface 210B, and the lateral surface 210C. According to an embodiment, the first surface 210A may be configured by a front plate 202 (e.g., a glass plate or a polymer plate including various coating layers), at least a part of which is substantially transparent. The second surface 210B may be configured by a rear plate 211 which is substantially opaque. The rear plate 211 may be formed of, for example, coated or colored glass, ceramic, a polymer, or a metal (e.g., aluminum, stainless steel (STS), or magnesium), or a combination of at least two of the above materials. The lateral surface 210C may be configured by a lateral frame (or a “lateral member”) 218 coupled to the front plate 202 and the rear plate 211 and including a metal and/or a polymer. In some embodiments, the rear plate 211 and the lateral frame 218 may be integrally configured and may include the same material (e.g., a metal material such as aluminum).

According to one or more embodiments, the front plate 202 may include, at opposite long edges of the front plate, first areas 210D which are bent and seamlessly extend from the first surface 210A toward the rear plate. According to one or more embodiments, such as in FIG. 2B, the rear plate 211 may include, at opposite long edges thereof, second areas 210E which are bent and seamlessly extend from the second surface 210B toward the front plate. In some embodiments, the front plate 202 or the rear plate 211 may include only one of the first areas 210D or the second areas 210E. In some embodiments, the front plate 202 and the rear plate 211 may not include the first areas 210D and the second areas 210E, but may include only a flat plane which is disposed parallel to the second surface 210B. In the above embodiments, when viewed from a lateral surface of the electronic device, the lateral frame 218 may have a first thickness (or width) on the lateral surface where the first areas 210D or the second areas 210E are not included, and may have a second thickness, which is thinner than the first thickness, on the lateral surface where the first areas or the second areas are included.

According to one or more embodiments, the electronic device 100 may include at least one of a display 280, an input device 203, audio output devices, such as external speaker 207 and call receiver 214, sensor modules, such as first sensor module 204 and second sensor module 219, camera modules, such as camera module 205, camera module 212, and camera module 213, key input devices 217, an indicator, and a connector 208. In some embodiments, the electronic device 200 may not include at least one (e.g., the key input devices 217 or the indicator) of the components or may additionally include other components.

For example, the display 280 may be exposed through a significant part of the front plate 202. In some embodiments, at least a part of the display 280 may be exposed through the front plate 202 forming the first areas 210D of the lateral surface 210C and the first surface 210A. The display 280 may be coupled to or disposed adjacent to a touch sensing circuit, a pressure sensor capable of measuring the strength (pressure) of a touch, and/or a digitizer which detects a magnetic field-type stylus pen. In some embodiments, at least a part of the sensor modules, such as first sensor module 204 and second sensor module 219 and/or at least a part of the key input devices 217 may be disposed in the first areas 210D and/or the second areas 210E.

The input device 203 may include a microphone. In some embodiments, the input device 203 may include a plurality of microphones disposed to sense the direction of sound. The audio output devices may include speakers. The speakers may include an external speaker 207 and a call receiver 214. In some embodiments, the microphone, the speakers, and the connector 208 may be disposed in the space of the electronic device 200 and exposed to an external environment through at least one hole formed in the housing 210. In some embodiments, the hole formed in the housing 210 may be used jointly for the microphone and the speakers. In some embodiments, the audio output devices, such as external speaker 207 and call receiver 214, may include a speaker (e.g., a piezo speaker) which operates while excluding the hole formed in the housing 210. In some embodiments, the electronic device 200 may include a tray member disposed through at least a part of the lateral frame 218.

The sensor modules, such as first sensor module 204 and second sensor module 219 may generate an electrical signal or a data value corresponding to an internal operating state of the electronic device 200 or an external environment state. The sensor modules, such as first sensor module 204 and second sensor module 219 may include, for example, a first sensor module 204 (e.g., a proximity sensor) and/or a second sensor module (e.g., a fingerprint sensor) disposed on the first surface 210A of the housing 210, and/or a third sensor module 219 (e.g., an HRM sensor) disposed on the second surface 210B of the housing 210. The fingerprint sensor may be disposed on the first surface 210A of the housing 210. A fingerprint sensor (e.g., an ultrasonic or optical fingerprint sensor) may be disposed under the display 280 on the first surface 210A. The electronic device 200 may further include a sensor module which is not illustrated, for example, at least one of a gesture sensor, a gyro sensor, an air pressure sensor, a magnetic sensor, an acceleration sensor, a grip sensor, a color sensor, an infrared (IR) sensor, a biometric sensor, a temperature sensor, a humidity sensor, or an illuminance sensor.

The camera modules, such as camera module 205, camera module 212, and camera module 213 may include a first camera device, as the camera module 205, disposed on the first surface 210A of the electronic device 200, a second camera device, as the camera module 212, disposed on the second surface 210B, and/or a flash 213. The camera module 205 and camera module 212 may include one or more optical systems (optics), an image sensor, and/or an image signal processor. The flash 213 may include, for example, a light-emitting diode or a xenon lamp. In some embodiments, two or more lenses (wide-angle and telephoto lenses) and image sensors may be disposed on one surface of the electronic device 200.

The key input devices 217 may be disposed on the lateral surface 210C of the housing 210. In an embodiment, the electronic device 200 may not include some or all of the above-mentioned key input devices 217, and a key input device 217, which is not included, may be implemented in another form, such as a soft key, on the display 280. In an embodiment, the key input devices 217 may be implemented using a pressure sensor included in the display 280.

For example, the indicator may be disposed on the first surface 210A of the housing 210. For example, the indicator may provide state information of the electronic device 200 in the form of light. In an embodiment, a light-emitting element may provide a light source which is interlocked with, for example, an operation of the camera module 205. The indicator may include, for example, an LED, an IR LED, and a xenon lamp.

The connector hole 208 may include a first connector hole 208 capable of receiving a connector (e.g., a USB connector or an IF module (interface connector port module)) for transmitting or receiving power and/or data to or from an external electronic device, and/or a second connector hole (or an earphone jack) capable of receiving a connector for transmitting or receiving an audio signal to or from an external electronic device.

The camera module 205 among the camera modules, such as camera module 205 and camera module 212, the sensor module 204 among the sensor modules, such as first sensor module 204 and second sensor module 219, or the indicator may be arranged to be visually exposed through the display 280. For example, the camera module 205, the sensor module 204, or the indicator may be disposed so as to be in contact with an external environment through a transmissive area or an opening perforated from an internal space of the electronic device 200 to the front plate 202 of the display 280. In one or more embodiments, an area where the display 280 and the camera module 205 face each other may be formed as a transmissive area having a certain transmittance as a part of an area that displays a content. In one or more embodiments, the transmissive area may be formed to have a transmittance ranging from about 5% to about 20%. The transmissive area may include an area overlapping with an effective area (e.g., a field-of-view area) of the camera module 205 through which light passes to be imaged by the image sensor to generate an image. For example, the transmissive area of the display 280 may include an area having a lower pixel density than the surrounding area. For example, the transmissive area may replace the opening. For example, the camera module 205 may include an under display camera (UDC). In an embodiment, the sensor module 204 may be disposed to perform its function without being visually exposed through the front plate 202 in the internal space of the electronic device. For example, in this case, an area of the display 280 facing the sensor module may not require a perforated opening.

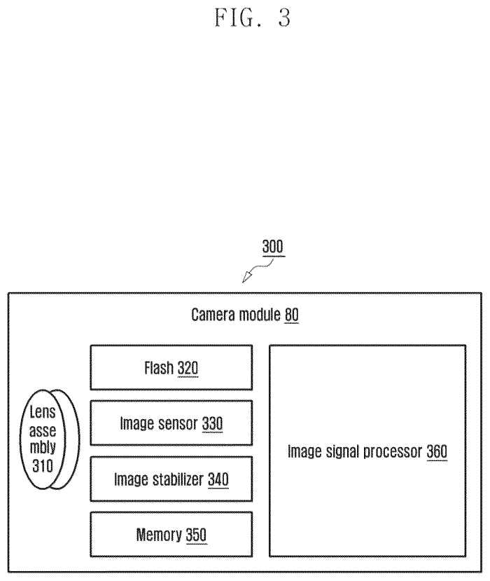

FIG. 3 is a block diagram 300 illustrating a configuration of a camera module (e.g., the camera module 80 of FIG. 1A or the camera modules, such as camera module 205, camera module 212, and camera module 213, of FIG. 2A and FIG. 2B) included in an electronic device (e.g., the electronic device 1 of FIG. 1A, the electronic device 100 of FIG. 1B, or the electronic device 200 of FIG. 2A and FIG. 2B) according to one or more embodiments.

Referring to FIG. 3, the camera module 80 may include a lens assembly 310, a flash 320, an image sensor 330, an image stabilizer 340, a memory 350 (e.g., a buffer memory), or an image signal processor 360. The lens assembly 310 may collect light emitted from a subject that is a target for image capturing. The lens assembly 310 may include one or more lenses. According to one or more embodiments, the camera module 80 may include a plurality of lens assemblies 310. In this case, the camera module 80 may form, for example, a dual camera, a 360-degree camera, or a spherical camera. Some of the plurality of lens assemblies 310 may have the same lens property (e.g., an angle of view, focal length, autofocus, f number, or optical zoom), or at least one lens assembly may have one or more lens properties which are different from lens properties of the other lens assemblies. The lens assembly 310 may include, for example, a wide-angle lens or a telephoto lens.

The flash 320 may emit light that is used to enhance light emitted or reflected from a subject. According to one or more embodiments, the flash 320 may include one or more light-emitting diodes (e.g., a red-green-blue (RGB) LED, a white LED, an infrared LED, or an ultraviolet LED), or a xenon lamp. The image sensor 330 may convert light emitted or reflected from a subject and transmitted through the lens assembly 310 into an electrical signal, and thus acquire an image corresponding to the subject. According to one or more embodiments, the image sensor 330 may include, for example, one image sensor selected from among image sensors having different properties, such as an RGB sensor, a black and white (BW) sensor, an IR sensor, and a UV sensor, a plurality of image sensors having the same property, or a plurality of image sensors having different properties. For example, each image sensor included in the image sensor 330 may be implemented using a charged coupled device (CCD) sensor or a complementary metal oxide semiconductor (CMOS) sensor.

The image stabilizer 340 may move at least one lens included in the lens assembly 310 or the image sensor 330 in a specific direction or control the operating characteristics of the image sensor 330 (e.g., adjusting read-out timing, etc.) in response to the movement of the camera module 80 or the electronic device 01 including the same. This allows at least some of the negative effects of the movement on a captured image to be compensated for. According to one or more embodiments, the image stabilizer 340 may detect such a movement of the camera module 80 or the electronic device 01 by using a gyro sensor or an acceleration sensor disposed inside or outside the camera module 80. According to one or more embodiments, the image stabilizer 340 may be implemented as, for example, an optical image stabilizer. The memory 350 may at least temporarily store at least a part of an image acquired through the image sensor 330 for the next image processing task. For example, when image acquisition is delayed due to a shutter, or when multiple images are acquired at high speed, the acquired original image (e.g., a Bayer-patterned image or a high-resolution image) is stored in the memory 350, and a copy image corresponding thereto (e.g., a low-resolution image) may be previewed through the display module 60. Thereafter, when a specified condition is satisfied (e.g., a user input or a system command), at least a part of the original image stored in the memory 350 may be acquired and processed, for example, by the image signal processor 360. According to one or more embodiments, the memory 350 may be configured as at least a part of the memory 30 or as a separate memory which operates independently therefrom.

The image signal processor 360 may perform one or more image processing operations on an image acquired through the image sensor 330 or an image stored in the memory 350. The one or more image processing operations may include, for example, depth map generation, 3D modeling, panorama generation, feature extraction, image synthesis, or image compensation (e.g., noise reduction, resolution adjustment, brightness adjustment, blurring, sharpening, or softening). Additionally or alternatively, the image signal processor 360 may perform control (e.g., exposure time control, readout timing control, or the like) for at least one (e.g., the image sensor 330) of the components included in the camera module 80. The image processed by the image signal processor 360 may be stored again in the memory 350 for further processing or provided to an external component (e.g., the memory 30, the display module 60, the electronic device 02, the electronic device 04, or the server 08) of the camera module 80. According to one or more embodiments, the image signal processor 360 may be configured as at least a part of the processor 20 or may be configured as a separate processor which operates independently from the processor 20. When the image signal processor 360 is configured as a separate processor from the processor 20, at least one image processed by the image signal processor 360 may be displayed through the display module 60 as is or after undergoing additional image processing by the processor 20.

According to one or more embodiments, the electronic device 01 may include a plurality of camera modules, a plurality of the camera module 80 for example, having different properties or functions, respectively. In this case, for example, at least one of the plurality of the camera module 80 may be a wide-angle camera, and at least another one may be a telephoto camera. Similarly, at least one of the plurality of camera module 80 may be a front camera, and at least another one may be a rear camera.

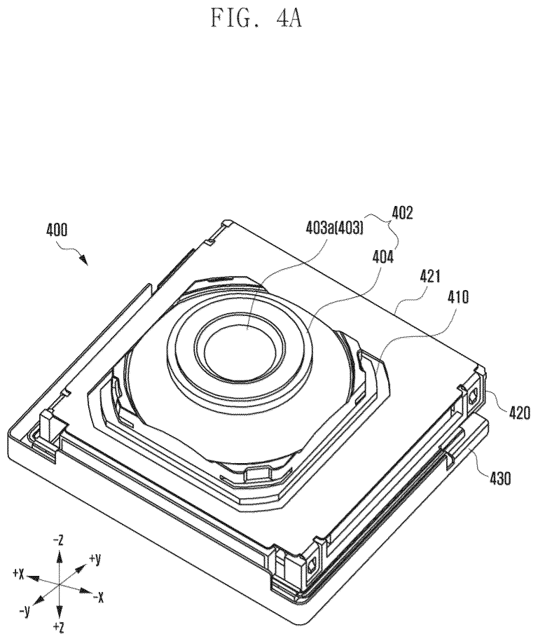

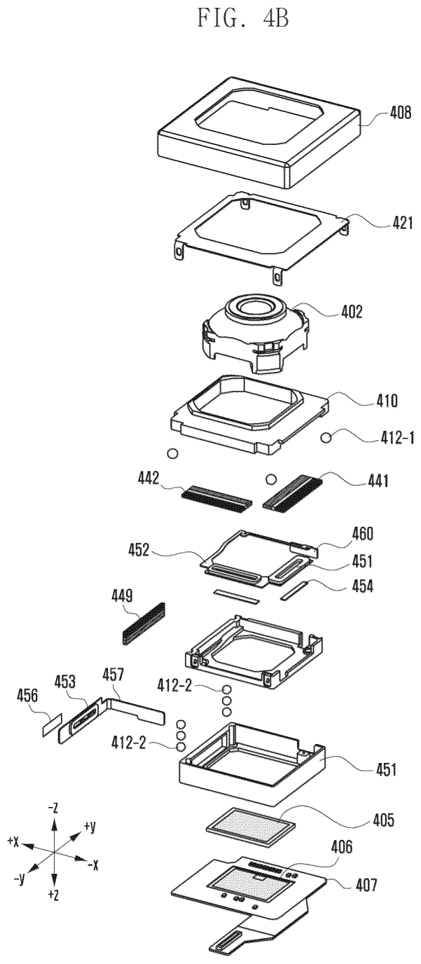

FIG. 4A is a perspective view illustrating a camera 401 of an electronic device according to various embodiments.

FIG. 4B is an exploded perspective view illustrating the camera 401 of the electronic device according to various embodiments.

Referring to FIG. 4A and FIG. 4B, a camera 401 (e.g., the camera modules, such as camera module 205, camera module 212, and camera module 213, of FIG. 2A and FIG. 2B) of an electronic device (e.g., the electronic device 100 of FIG. 1 or the electronic device 200 of FIG. 2A, FIG. 2B, and FIG. 3) may include an optical system 402, an OIS housing 410, an AF housing 420, and a base housing 430. The optical system 402 may be a component which forms an image by focusing light entering from the outside of the camera 401 onto an image sensor 406 (or an imaging surface of the image sensor 406) by using one or more optical elements 403 (e.g., a lens 403a, a reflector, a prism, and/or a polarizer). A path of light moving along the optical centers of the optical elements 403 may be defined as an optical axis. An optical axis of the optical system 402 may be aligned with respect to a predetermined direction (e.g., the z-axis) of the electronic device. For example, the optical system 402 may be aligned to receive light from the −z-axis direction. In various embodiments, the optical system 402 may include a barrel 404 which holds the optical elements 403. In addition to the optical elements 403, other optical components, such as an aperture, may be positioned within the barrel 404.

The OIS housing 410 may be a housing which includes the optical system 402 and is configured to move the optical system 402 for an optical image stabilization (OIS) operation. For example, the OIS housing 410 may be configured to move in a direction substantially perpendicular to an optical axis (e.g., in a direction along the x-y plane perpendicular to the z-axis). The OIS housing 410 may be driven by a magnetic force. For example, one or more magnets (e.g., a first magnet 441 and a second magnet 442) are attached to the OIS housing 410, and the magnets move due to a magnetic field of a coil described later, so that the OIS housing 410 may move. The first magnet 441 and the second magnet 442 may be oriented perpendicular to each other in a plane (e.g., the x-y plane perpendicular to the z-axis) perpendicular to the optical axis. Each of the first magnet 441 and the second magnet 442 may be responsible for driving the OIS housing 410 along one axis. For example, the first magnet 441 may be responsible for driving the OIS housing 410 along the x-axis (the +x direction and the −x direction), and the second magnet 442 may be responsible for driving the OIS housing 410 along the y-axis (the +y direction and the −y direction).

The AF housing 420 may be a member which is coupled with the OIS housing 410 to be movable for an OIS operation of the OIS housing 410. The AF housing 420 may be configured to move the OIS housing 410 and the optical system 402 in an optical axis direction (e.g., the z direction and the −z direction) for a focusing operation (e.g., autofocusing).

In various embodiments, a yoke (e.g., a first yoke 454 and a second yoke 455) may be positioned in the AF housing 420. An AF yoke 456 may be a member having a soft magnetic material such that a magnetic field line formed by a third coil 453 flows through the inside of the AF yoke 456. The AF yoke 456 may be positioned in a direction opposite to a direction in which a third magnet 449 is positioned with respect to the third coil 453. Therefore, the AF yoke 456 may cause the magnetic field line formed by the third coil 453 to be concentrated in the direction of the third magnet 449.

In various embodiments, the camera 401 may include a coil (e.g., a first coil 451 and a second coil 452). The coil may be disposed on a coil circuit board 460. The first coil 451 and the second coil 452 may be configured such that an electromagnetic force (e.g., Lorentz force) is generated between the first coil 451 and the first magnet 441 and between the second coil 452 and the second magnet 442 when a current is applied.

In various embodiments, the camera 401 may include a Z stopper 421. The Z stopper 421 may be coupled with the AF housing 420 with the OIS housing 410 interposed therebetween. The Z stopper 421 may be configured to limit the movement of the OIS housing 410 in the optical axis direction (e.g., the −z direction). The Z stopper 421 may have an opening formed to allow light entering the optical system 402 to at least partially pass therethrough.

In various embodiments, the camera 401 may include an OIS ball member 412-1 positioned between the AF housing 420 and the OIS housing 410, and movably supporting the OIS housing 410 with respect to the AF housing 420.

The base housing 430 may be a member which at least partially receives the OIS housing 410 to enable movement for the focusing operation of the AF housing 420. In various embodiments, an AF ball member 412-2 may be positioned between the inside of the base housing 430 and the outside of the AF housing 420 to movably support the AF housing 420 with respect to the base housing 430. The image sensor 406 disposed on an image sensor substrate 407 may be positioned in one direction (e.g., the +z direction) of the base housing 430, and the optical system 402 may be positioned in the opposite direction (e.g., the −z direction) of the one direction.

In various embodiments, the electronic device may include the third magnet 449 and the third coil 453 which drive the focusing operation of the AF housing 420. As a non-limiting example, the third magnet 449 may be disposed in the AF housing 420, and the third coil 453 may be positioned in the base housing 430. For example, the third coil 453 may be disposed on a third coil substrate 457, and the third coil substrate 457 may be positioned in the base housing 430. In addition, as a non-limiting example, the third coil 453 may be disposed in the AF housing 420, and the third magnet 449 may be positioned in the base housing 430. For example, the third coil 453 may be disposed on the third coil substrate 457, and the third coil substrate 457 may be positioned in the AF housing 420. In various embodiments, the third magnet 449 and the third coil 453 may be arranged so as to face each other.

In various embodiments, the AF yoke 456 may be positioned in the base housing 430. The AF yoke 456 may be a member having a soft magnetic material such that a magnetic field line formed by the third coil 453 flows through the inside of the AF yoke 456. The AF yoke 456 may be positioned in a direction opposite to a direction in which the third magnet 449 is positioned with respect to the third coil 453. Therefore, the AF yoke 456 may cause the magnetic field line formed by the third coil 453 to be concentrated in the direction of the third magnet 449.

In various embodiments, the AF ball member 412-2 positioned between the inside of the base housing 430 and the outside of the AF housing 420 to movably support the AF housing 420 with respect to the base housing 430 may be included.

In various embodiments, the camera 401 may include a shield can 408. The shield can 408 may be a member including a conductive material and configured such that the components of the camera 401, excluding a part of the optical system 402, are positioned inside the shield can 408. The shield can 408 may be configured to block electromagnetic interference affecting the camera 401. For example, the shield can 408 may be configured to block electromagnetic interference (EMI) applied to the camera 401 from the outside of the camera 401 and EMI generated by electromagnetic noise inside the camera 401. The shield can 408 may have an opening formed to allow light entering the optical system 402 to at least partially pass therethrough.

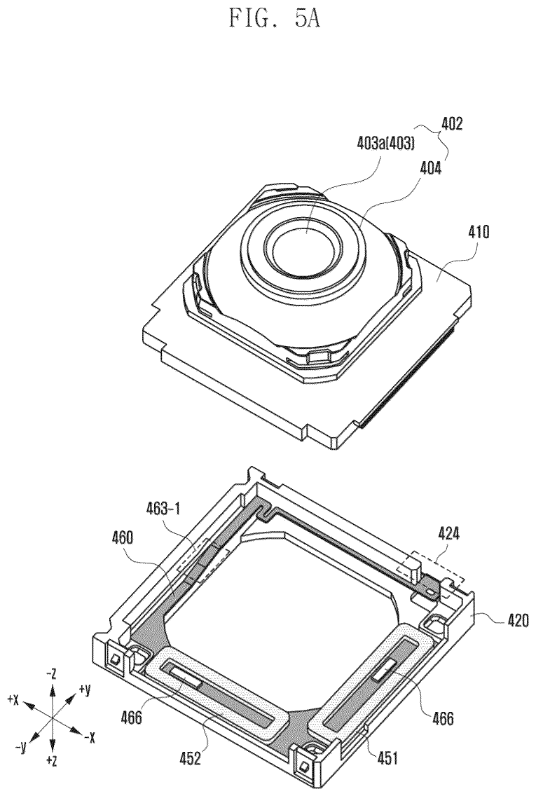

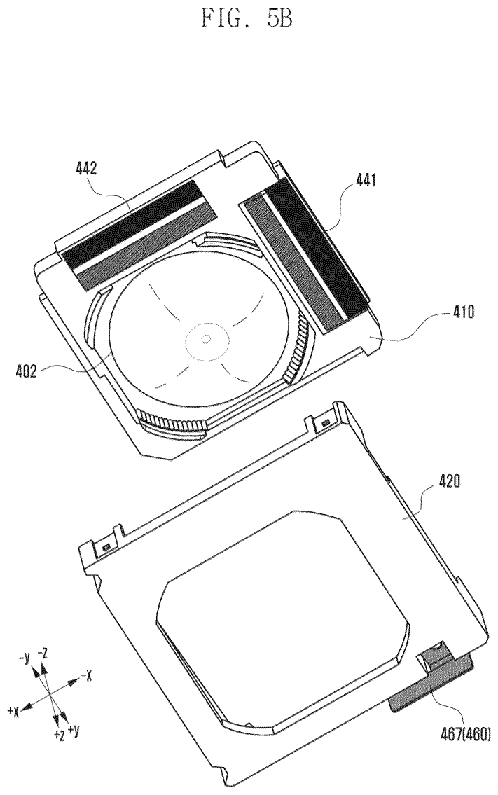

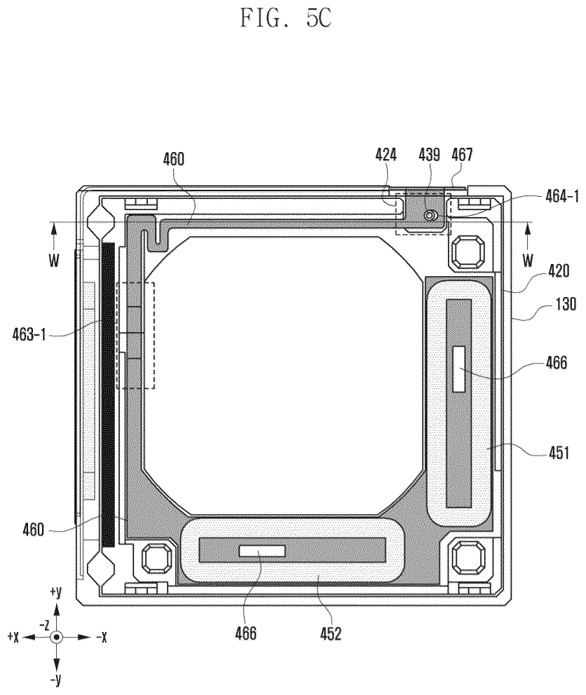

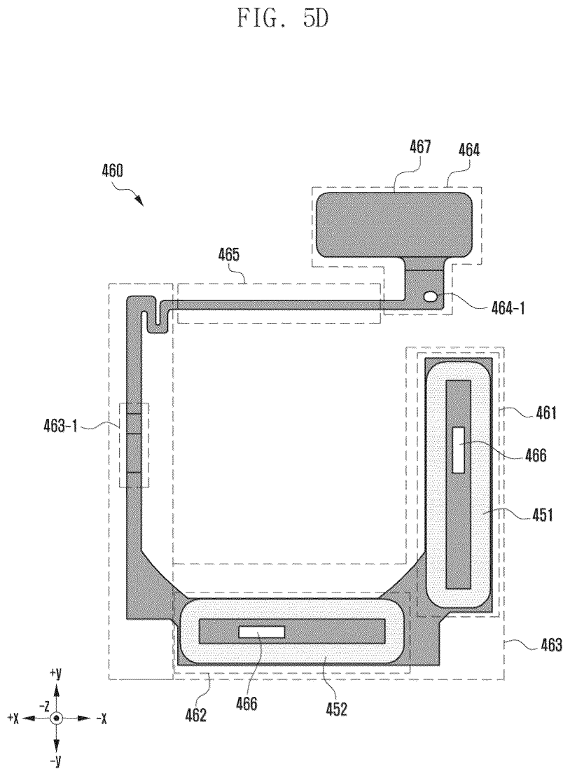

FIG. 5A is an exploded perspective view illustrating the AF housing 420 and the OIS housing 410 of the electronic device according to various embodiments.

FIG. 5B is an exploded perspective view illustrating the AF housing 420 and the OIS housing 410 of the electronic device according to various embodiments.

FIG. 5C is a plan view illustrating the AF housing 420 of the electronic device according to various embodiments.

FIG. 5D is a plan view illustrating the coil circuit board 460 of the electronic device according to various embodiments.

Referring to FIG. 5A, FIG. 5B, and FIG. 5C, the first magnet 441 and the second magnet 442 may be arranged in the OIS housing 410. For example, the first magnet 441 and the second magnet 442 may be attached to a lower surface (e.g., an outer surface of the OIS housing 410 facing the +z direction) of the OIS housing 410. The coil circuit board 460 may be disposed in the AF housing 420, and the first coil 451 and the second coil 452 may be arranged in the coil circuit board 460.

The coil circuit board 460 may be positioned on a bottom surface (e.g., an inner surface of the AF housing 420 positioned in the −z direction) of the AF housing 420. In various embodiments, the first coil 451 may be positioned to face the first magnet 441 in a state where the AF housing 420 and the OIS housing 410 are assembled, and the second coil 452 may be positioned to face the second magnet 442 in a state where the AF housing 420 and the OIS housing 410 are assembled.

In various embodiments, the first magnet 441 and the second magnet 442 may be arranged substantially perpendicular to each other on the bottom surface of the OIS housing 410, and the first coil 451 and the second coil 452 may be arranged substantially perpendicular to each other so as to face the first magnet 441 and the second magnet 442. The first magnet 441 and the first coil 451 may generate an electromagnetic force in a first direction (e.g., the x-axis direction) substantially perpendicular to an optical axis direction (e.g., the z-axis direction), so as to drive the OIS housing 410 in the first direction, and the second magnet 442 and the second coil 452 may generate an electromagnetic force in a second direction (e.g., the y-axis direction) substantially perpendicular to the optical axis direction (e.g., the z-axis direction) and the first direction, so as to drive the OIS housing 410 in a second direction.

In various embodiments, the first coil 451 may extend in one direction in a plane (e.g., the x-y plane perpendicular to the z-axis) substantially perpendicular to the optical axis direction, and the second coil 452 may extend in another direction substantially perpendicular to the direction in which the first coil extends. For example, the first coil 451 may extend in the y-axis direction, and the second coil 452 may extend in the x-axis direction. That is, the first coil 451 may extend perpendicular to a direction in which a driving force is applied to the first magnet 441, and the second coil 452 may extend perpendicular to a direction in which a driving force is applied to the second magnet 442.

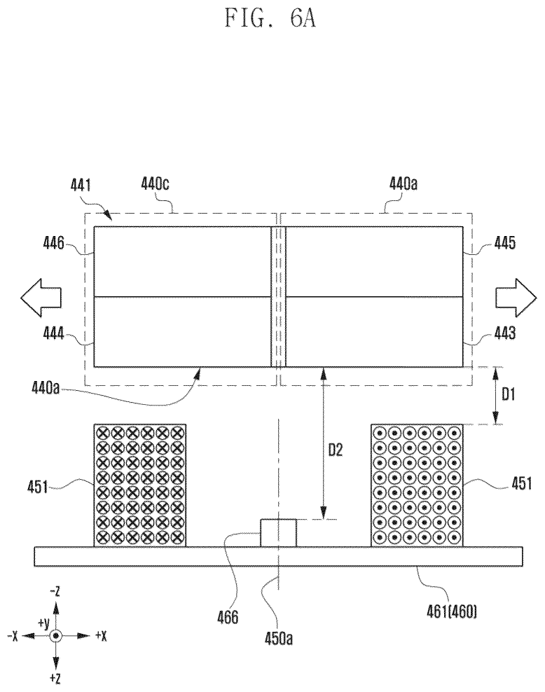

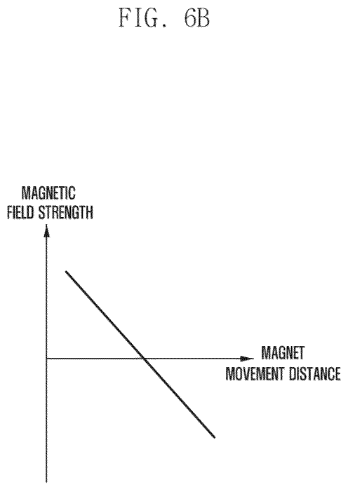

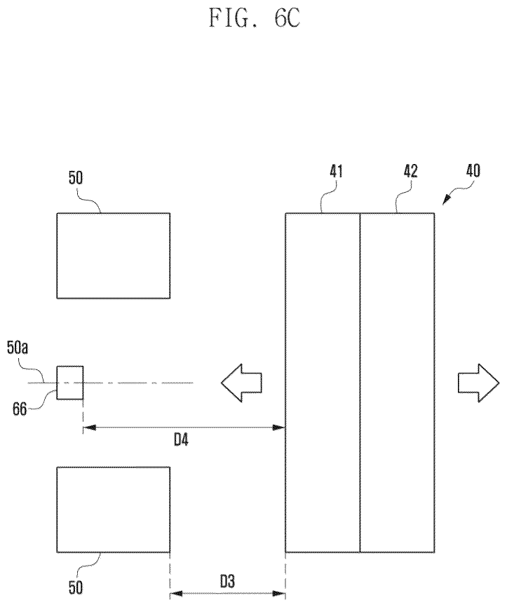

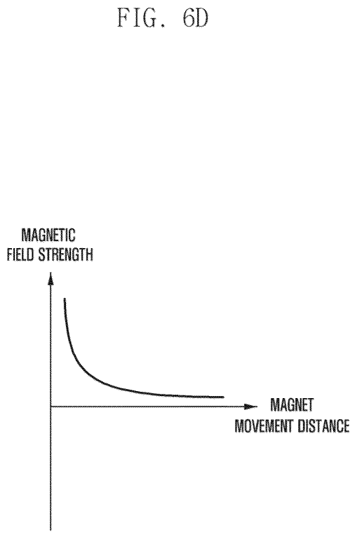

In various embodiments, the first coil 451 and the second coil 452 may be arranged such that a magnetic axis (e.g., a magnetic axis 450a of FIG. 6A) faces the optical axis direction. For example, the first coil 451 and the second coil 452 may be configured to form a loop or spiral conductive path in a plane oriented substantially perpendicular to an optical axis (e.g., the z-axis). For example, each of the first coil 451 and the second coil 452 may include a conductor wound in a direction substantially perpendicular to the optical axis. That is, the conductors of the first coil 451 and the second coil 452 may be wound around a magnetic axis 450a oriented substantially parallel to the optical axis. An electromagnetic force (e.g., a magnetic component (−qv×B) of the Lorentz force) may be generated between the first coil 451 and the first magnet 441 and between the second coil 452 and the second magnet 442, and thus the OIS housing 410 may be driven. In addition, as a non-limiting example, the OIS housing 410 may be driven as a result of a magnetic force that a magnetic field generated by applying a current to the wound conductors of the first coil 451 and the second coil 452 exerts on magnetic poles of the first magnet 441 and the second magnet 442. The electromagnetic force generated between the first coil 451 and the first magnet 441 and between the second coil 452 and the second magnet 442 will be described in more detail later.

Referring to FIG. 5D, the coil circuit board 460 may include a first portion 461 in which the first coil 451 is disposed, and a second portion 462 in which the second coil 452 is disposed. The first portion 461 and the second portion 462 may be formed substantially perpendicular to each other in a plane (e.g., the x-y plane perpendicular to the z-axis) perpendicular to the optical axis. The coil circuit board 460 may include a circuit (e.g., a drive circuit) configured to energize or excite the first coil 451 and/or the second coil 452 by applying a current to the first coil 451 and/or the second coil 452 according to an OIS control signal. For example, the drive circuit may control the amount of current flowing through a coil according to a control signal. In various embodiments, the coil circuit board 460 may include a printed circuit board (PCB), a flexible printed circuit board (FPCB), and/or a rigid-flexible printed circuit board (RFPCB).

In various embodiments, the coil circuit board 460 may include a magnetic sensor 466. The magnetic sensor 466 may be disposed in each of the first coil 451 and the second coil 452. For example, the magnetic sensor 466 may be disposed in one area inside a loop of the first coil 451, and another magnetic sensor 466 may be disposed in one area inside a loop of the second coil 452. The magnetic sensor 466 may include, for example, a Hall effect sensor.

In various embodiments, the coil circuit board 460 may include a first fixing part 463 fixed to the AF housing 420, and a second fixing part 464 fixed to the base housing 430. The second fixing part 464 may include a connector 467 which supplies power and a control signal to the first coil 451 and the second coil 452. The connector 467 may be electrically connected to a common circuit board modularized together with the camera 401 and/or a circuit board of the electronic device. In various embodiments, the second fixing part 464 may be formed of a flexible printed circuit board, having at least a partial area 463-1 of which has flexibility such that the connector 467 may be coupled to another member.

In various embodiments, the second fixing part 464 may include a fixing hole 464-1. The fixing hole 464-1 may be formed through the second fixing member 464 so as to allow a fixing protrusion 439 of the base housing 430 to pass therethrough. In various embodiments, the fixing hole 464-1 may have a long hole shape. Therefore, the fixing hole 464-1 may fix the second fixing part 464 to the base housing 430 in a predetermined direction (e.g., the +y and −y directions), and allow movement in other directions (e.g., the +x and −x directions). Therefore, the fixing hole 464-1 may allow the coil circuit board 460 to accommodate a change in position of the AF housing 420 with respect to the base housing 430.

In various embodiments, the coil circuit board 460 may include a flexible part (flexible region) 465 positioned between the first fixing part 463 and the second fixing part 464. Therefore, the flexible part 465 may have flexibility such that the coil circuit board 460 accommodates a change in position of the AF housing 420 with respect to the base housing 430.

Referring again to FIG. 5C and FIG. 5D, the AF housing 420 may have an avoidance groove 424 formed so that the AF housing 420 and the second fixing part 464 do not overlap with respect to an operation direction (e.g., the +z-axis and −z-axis directions) of the AF housing. Therefore, the AF housing 420 may move without interference with the coil circuit board 460 during an AF operation.

FIG. 6A is a schematic view illustrating a coil and a magnet of the camera 401 according to various embodiments.

FIG. 6B is a graph illustrating the strength of a magnetic field with respect to the amount of movement of a magnet of the camera 401 according to various embodiments.

FIG. 6C is a schematic view illustrating a coil and a magnet of the camera 401 according to a comparative example.

FIG. 6D is a graph illustrating the strength of a magnetic field with respect to the amount of movement of a magnet of the camera 401 according to a comparative example.

Referring to FIG. 6A, magnetic poles (e.g., a first magnetic pole 443 and a second magnetic pole 444) of a magnet (e.g., the first magnet 441, the second magnet 442, and/or the third magnet 449) according to embodiments of the disclosure may be positioned to apply a magnetic force in a direction perpendicular to the magnetic axis 450a of a coil (e.g., the first coil 451, the second coil 452, and/or the third coil 453) of the camera 401. For example, the magnetic poles of the first magnet 441 may be positioned to generate an electromagnetic force in a first direction (e.g., the +x or −x direction) perpendicular to the magnetic axis 450a (and an optical axis substantially parallel thereto) of the first coil 451 when a current flows through the first coil 451. For example, the second magnetic pole 444 (e.g., either the N pole or the S pole) of the magnet may be positioned to be spaced apart from the first magnetic pole 443 (e.g., the other of the N pole or the S pole) in a direction perpendicular to the magnetic axis 450a of the coil. For example, in the example of the first magnet 441 illustrated in FIG. 6A, the second magnetic pole 444 may be positioned to be spaced apart from the first magnetic pole 443 in the x-axis direction. That is, a relative position vector of the second magnetic pole 444 with respect to the first magnetic pole 443 of the magnet may be parallel to the direction of a force applied by the magnet. The above description may be equally applied to the second magnet 442, the third magnet 449, the second coil 452, and the third coil 453 as long as it is not contradictory.

The first magnetic pole 443 and the second magnetic pole 444 of a magnet (e.g., the first magnet 441) are arranged in a direction perpendicular to a magnetic axis of a coil (e.g., the first coil 451), and thus when a current is applied to the coil, either an electromagnetic attractive force or a repulsive force may be generated between the coil and the first magnetic pole 443, and the other of the electromagnetic attractive force or the repulsive force may be generated between the coil and the second magnetic pole 444. Therefore, a force of a directional component (e.g., the z direction and the −z direction in FIG. 6A) which pulls or pushes the coil toward or away from the magnet is canceled through offsetting, and an electromagnetic force of a directional component substantially perpendicular to the magnetic axis 450a of the coil (that is, a directional component substantially parallel to the surface of the coil facing the magnet, for example, the +x and −x directions in FIG. 6A) acts between the coil and the magnet. In addition, the electromagnetic force generated between the magnet and the coil may be parallel to a relative position vector (e.g., the −x axis) of the second magnetic pole 444 with respect to the first magnetic pole 443.

For example, in the embodiment of FIG. 6A, when a clockwise current is applied to the first coil 451 as viewed in the +z direction, if the first magnetic pole 443 is an S pole and the second magnetic pole 444 is an N pole, the first magnet 441 may apply an electromagnetic force in the −x direction to the first coil 451, and the first magnet 441 may move in the +x direction due to a resulting reaction force. In addition, if the direction of a current is counterclockwise, it will be obvious that the first magnet 441 may move in the −x direction. By the same principle, the second magnet 442 may apply an electromagnetic force in the +y or −y direction to the second coil 452, and thus the second magnet 442 may move in the −y or +y direction due to a resulting reaction force.

As described above, the first coil 451 and the second coil 452 have the magnetic axis 450a substantially parallel to an optical axis (e.g., the z-axis), and the first magnet 441 and the second magnet 442 may drive the OIS housing in a direction (e.g., the x-axis and the y-axis) perpendicular to the optical axis.

According to the driving method described above, when the magnet is moved by the coil, a distance D1 between the coil and the magnet may be maintained substantially constant. Therefore, even when a relative movement distance (e.g., a movement distance in the +x or −x direction) of the magnet increases, a decrease in a magnetic force between the coil and the magnet is relatively small. Therefore, even when a movement distance of the magnet increases due to an increased driving amount for optical image stabilization, a driving force of the OIS housing 410 may be maintained or a decrease in the driving force may be minimized. In addition, since the distance D1 between the coil and the magnet is maintained substantially constant, it is easy to reduce a distance between the coil and the magnet compared to a comparative example described later, and thus the magnetic force between the coil and the magnet may be improved. In addition, a distance D2 between the magnet and the magnetic sensor 466 arranged on the coil circuit board 460 may also be maintained substantially constant despite movement (movement in the x-axis direction) of the magnet. Accordingly, position measurement of the magnet by the magnetic sensor 466 may be facilitated.

Referring to FIG. 6B, the strength of a magnetic field of the magnet measured by the magnetic sensor 466 may be changed linearly or quasi-linearly according to a relative movement (for example, movement in the x-axis direction) between the magnet and the coil. For example, when the magnet is positioned at a neutral point, the strength of the magnetic field measured by the magnetic sensor 466 may be substantially 0, when the magnet moves in one direction from the neutral point, the strength of the magnetic field may increase linearly, and when the magnet moves in the opposite direction from the neutral point, the magnetic field may increase linearly in the opposite direction. Based on such a linear relationship, the magnetic sensor 466 may relatively accurately measure a relative movement distance of the magnet. In addition, the accuracy of the magnetic sensor 466 may be maintained even when a movement distance of the magnet increases. This may be because the distance between the magnetic sensor 466 and the magnet is maintained substantially constant despite the movement of the magnet, as shown in FIG. 6A.

Referring to FIG. 6C, a magnet 40 and a coil 50 of a comparative example may be arranged so that an arrangement direction of magnetic poles, magnetic pole 41 and magnetic pole 42, of the magnet and a magnetic axis 50a of the coil are substantially parallel and face each other. That is, the comparative example may be assumed in which the coil operates like a bar magnet and the magnet is directly driven in a direction in which the magnetic axis 50a of the coil faces by an attractive/repulsive force between magnetic poles of the coil and the magnetic poles of the magnet. In the comparative example, a distance D3 between the coil 50 and the magnet 40 may be changed as the magnet 40 moves. In addition, a distance D4 between a magnetic sensor 66 and the magnet 40 may also be changed as the magnet 40 moves.

Referring to FIG. 6D, the strength of a magnetic field of the magnet 40 measured by the magnetic sensor 66 in the comparative example may decrease nonlinearly depending on the amount of movement of the magnet. This may be because the strength of the magnetic field applied by the magnet 40 (e.g., a magnetic dipole) decreases inversely proportional to the second or third power of a distance as the distance increases. Due to the nonlinear and rapid decrease in the magnetic field, as the distance between the magnetic sensor 66 and the magnet 40 increases, it becomes difficult to measure an exact position of the OIS housing through the magnetic sensor 66, and thus the position control precision of the OIS housing decreases. In addition, since the strength of the magnetic field of the magnet 40 acting on the side of the coil 50 rapidly and nonlinearly decreases, the strength of a magnetic force for driving the magnet 40 becomes weaker, and thus the driving force for driving the OIS housing may become weaker as a movement distance of the OIS housing increases.

Referring again to FIG. 6A, compared to the comparative example, the decrease in the driving force of the housing according to the movement distance of the magnet is less than that of the comparative example, and a measurement value of the magnetic sensor 466 according to the movement distance of the magnet is relatively more linear, so that it can be seen that the position control capability of the magnet based on the magnetic sensor 466 is good.

In various embodiments, the magnet according to the embodiments of the disclosure may include a single-sided two-pole magnet. The single-sided two-pole magnet may be magnetized so that a main magnetic field surface 440a faces the coil. For example, the magnet may be magnetized such that the first magnetic pole 443 faces the coil and a third magnetic pole 445 faces in the opposite direction of the coil in a first zone 440b, and may be magnetized such that the second magnetic pole 444 faces the coil and a fourth magnetic pole 446 faces in the opposite direction of the coil in a second zone 440c. Between the first zone 440b and the second zone 440c, a zone (neutral zone) that is substantially non-magnetized due to the cancellation of magnetization may exist. The single-sided two-pole magnet magnetized in the above-described direction may have its main magnetic field surface 440a facing the coil, so that the magnetic force between the magnet and the coil may be enhanced. For example, one or more embodiments including a single-sided two-pole magnet may have an enhanced magnetic force, owing to the magnet linearly magnetized like a bar magnet, compared to one or more embodiments (e.g., FIG. 6C) in which the main magnetic field surface 440a does not face the coil.

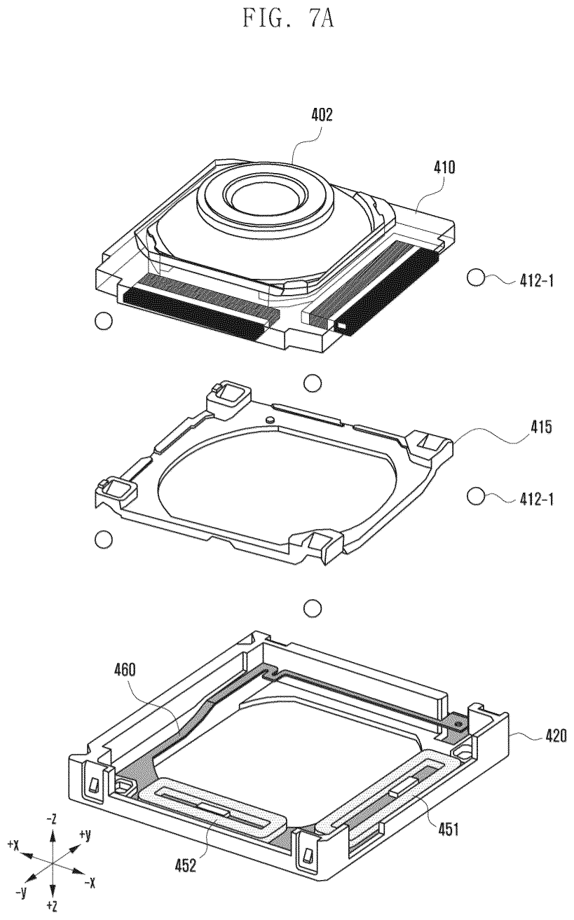

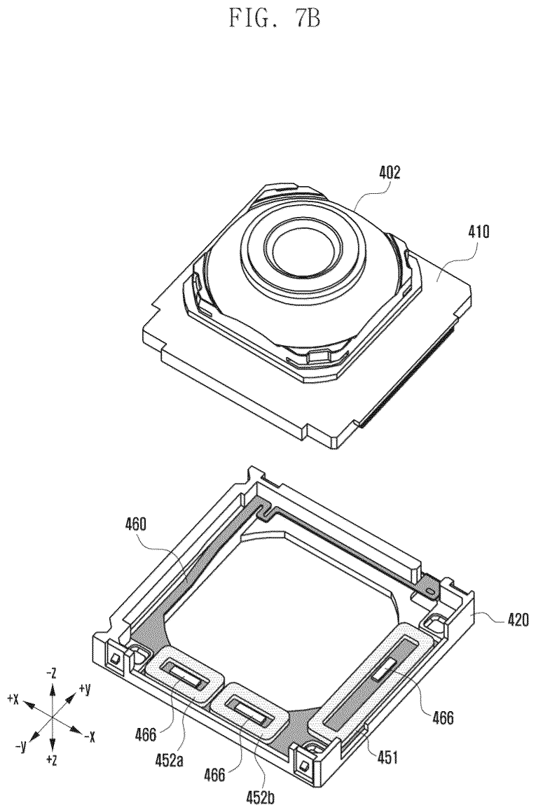

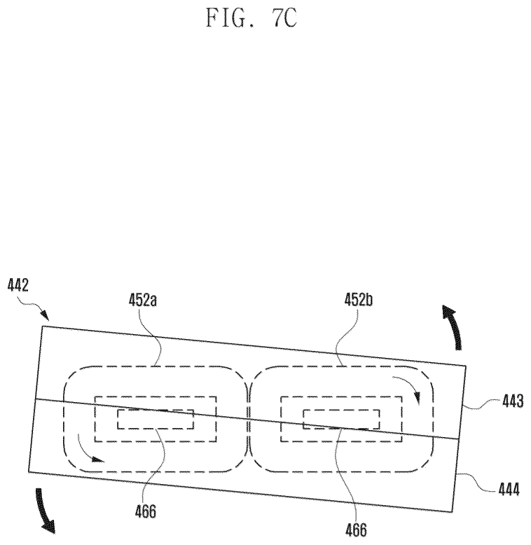

FIG. 7A is an exploded perspective view illustrating the camera 401 according to various embodiments.

FIG. 7B is an exploded perspective view illustrating the camera 401 according to various embodiments.

FIG. 7C is a schematic view illustrating a torque offsetting operation of the camera 401 according to various embodiments.

Referring to FIG. 7A, the camera 401 according to various embodiments may include a guide member 415. The guide member 415 may be a member which is positioned within the AF housing 420 and limits rotation (for example, a rotational motion with an optical axis (z-axis) as a rotation axis or a rotational motion in a roll direction) of the OIS housing 410. A magnetic force generated by the first magnet 441 and the second magnet 442 and the first coil 451 and the second coil 452 may include a rotational motion component together with a translational motion component (e.g., a magnetic force of components in a first direction (x-axis direction) and a second direction (y-axis direction)). Therefore, the guide member 415 may support the OIS housing 410 to move accurately for optical image stabilization by limiting a rotational motion of the OIS housing 410 while guiding a translational motion of the OIS housing 410. A ball member 412-1 may be positioned to movably support the guide member 415 with respect to the AF housing 420 and the OIS housing 410. For example, a plurality of ball members 412-1 may be positioned on an upper surface and a lower surface of the guide member 415.

Referring to FIG. 7B, the second coil 452 of the camera 401 according to various embodiments may include a plurality of coils. For example, the second coil 452 may include a (2-1)th coil 452a and a (2-2)th coil 452b which are arranged substantially parallel to each other. The (2-1)th coil 452a and the (2-2)th coil 452b may be arranged in a direction substantially perpendicular to a second direction (e.g., +y and −y directions) which is a direction in which a force is applied to the second magnet 442. For example, the (2-1)th coil 452a and the (2-2)th coil 452b may be arranged parallel to a first direction (x-axis direction). The magnetic sensor 466 may be arranged in each of loops of the (2-1)th coil 452a and the (2-2)th coil 452b.

Referring to FIG. 7C, when currents of different magnitudes or directions flow through the (2-1)th coil 452a and the (2-2)th coil 452b, a torque may be generated in the second magnet 442. The torque generated in the second magnet 442 by the (2-1)th coil 452a and the (2-2)th coil 452b may offset various torques generated in an OIS coil. Therefore, the rotational motion of the OIS housing 410 may be limited by individually controlling the currents of the (2-1)th coil 452a and the (2-2)th coil 452b.

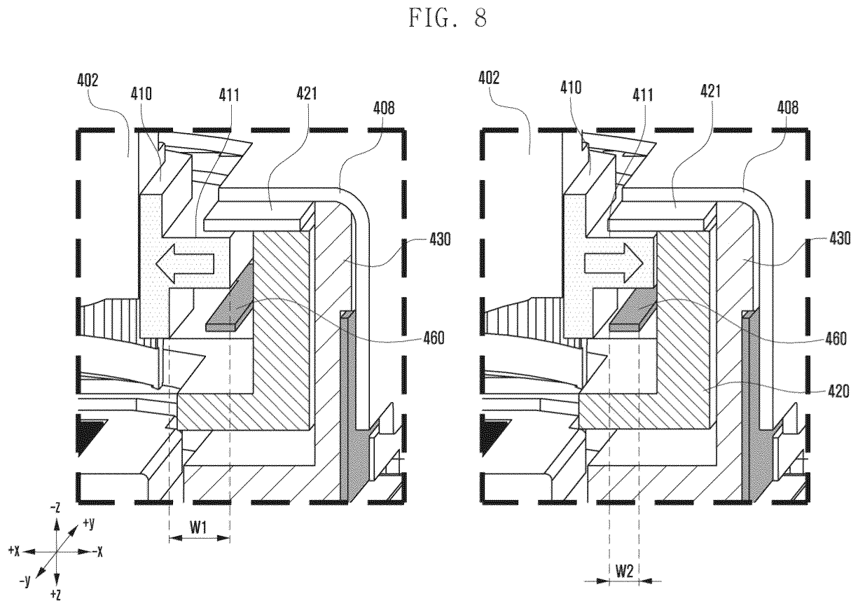

FIG. 8 is a cross-sectional view of the camera 401 according to various embodiments.

Referring to FIG. 8, the OIS housing 410 may include a stopper 411. The stopper 411 may be a member which protrudes from a lateral surface (e.g., a surface facing the x direction and/or the y direction) of the OIS housing 410. The stopper 411 may be configured to be in contact with an inner surface of the AF housing 420 when the OIS housing 410 moves, and thus limit the movement of the OIS housing 410.

In various embodiments, a length W1 of the stopper 411 protruding from the lateral surface of the OIS housing 410 may be equal to or greater than a width W2 of the coil circuit board 460. For example, a part of the coil circuit board 460 may be positioned between the OIS housing 410 and the AF housing 420, and in the part of the coil circuit board 460, the width W2 of the coil circuit board 460 may be equal to or smaller than the length W1 by which the stopper 411 protrudes from the lateral surface of the OIS housing 410. By limiting the movement of the OIS housing 410 by the stopper 411, the coil circuit board 460 extending through a space between the AF housing 420 and the OIS housing 410 can be prevented or reduced from being damaged by being pinched between the OIS housing 410 and the AF housing 420. In addition, since the Z stopper 421 coupled to the AF housing 420 limits a z-axis movement of the stopper 411, the z-axis movement of the OIS housing 410 may be limited during an AF operation.

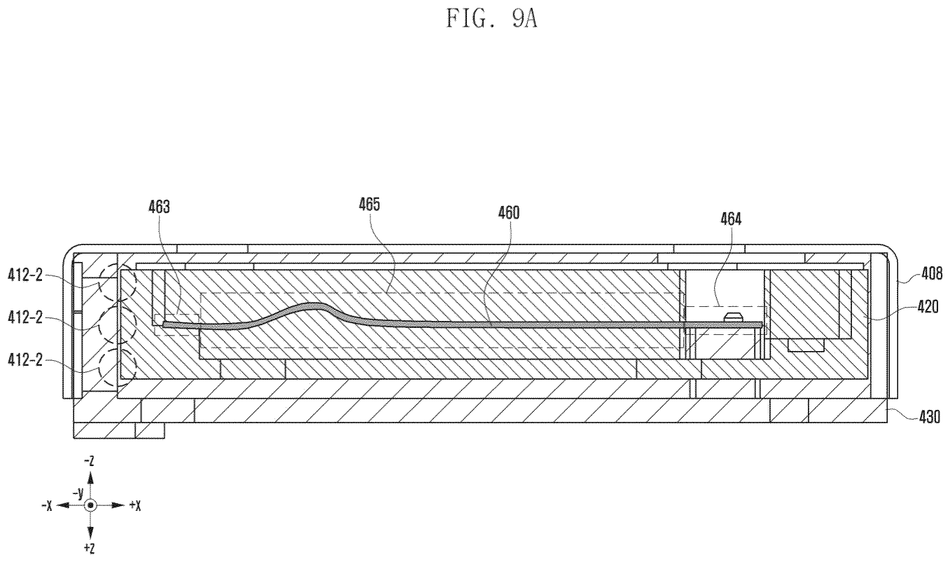

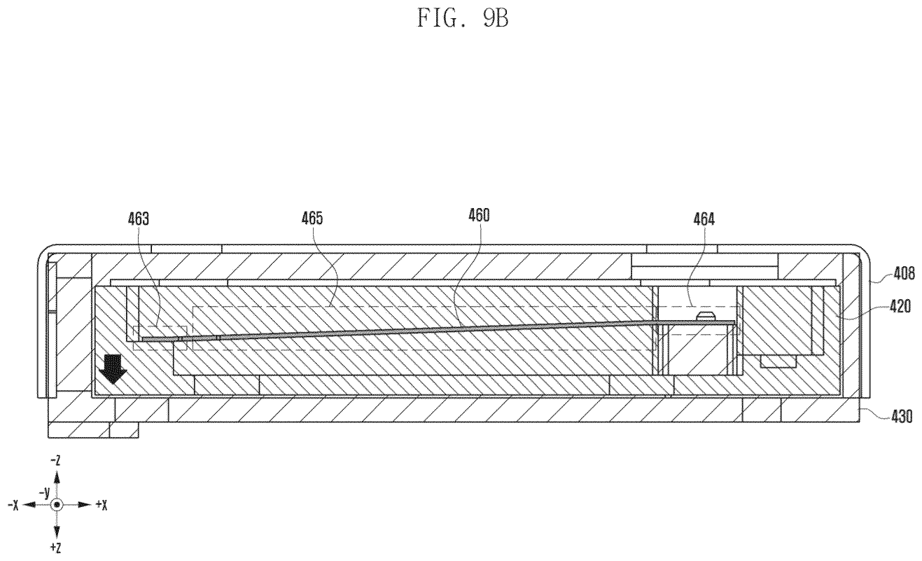

FIG. 9A is a cross-sectional view of the camera 401 according to various embodiments.

FIG. 9B is a cross-sectional view illustrating an AF operation of the camera 401 according to various embodiments.

FIG. 9A and FIG. 9B are cross-sectional views illustrating the W-W direction of FIG. 5C.

Referring to FIG. 5C, FIG. 5D, and FIG. 9A, the coil circuit board 460 may include the first fixing part 463 fixed to the AF housing 420, the second fixing part 464 fixed to the base housing 430, and the flexible part (flexible region) 465 positioned between the first fixing part 463 and the second fixing part 464. In various embodiments, the coil circuit board 460 may be entirely configured by a flexible printed circuit board (FPCB), or may be a rigid-flexible printed circuit board (RFPCB) in which the flexible part 465 is made of a flexible substrate. As a non-limiting example, the coil circuit board 460 may be a PCB and an FPCB electrically connected thereto, and the FPCB portion may correspond to the flexible part 465.

In various embodiments, a length of the flexible part 465 may be longer than a straight-line distance between the first fixing part 463 and the second fixing part 464. For example, as illustrated in FIG. 9A, the flexible part 465 has an extra length compared to the straight-line distance between the first fixing part 463 and the second fixing part 464, and thus can be bent.

Referring to FIG. 9B, when the AF housing 420 moves (e.g., moves in the z-axis direction) with respect to the base housing 430 by a focusing operation, the distance between the first fixing part 463 and the second fixing part 464 may increase. The flexible part 465 has an extra length, and thus the flexible part 465 extending from the AF housing 420 to the base housing 430 can ensure smooth movement of the AF housing 420.

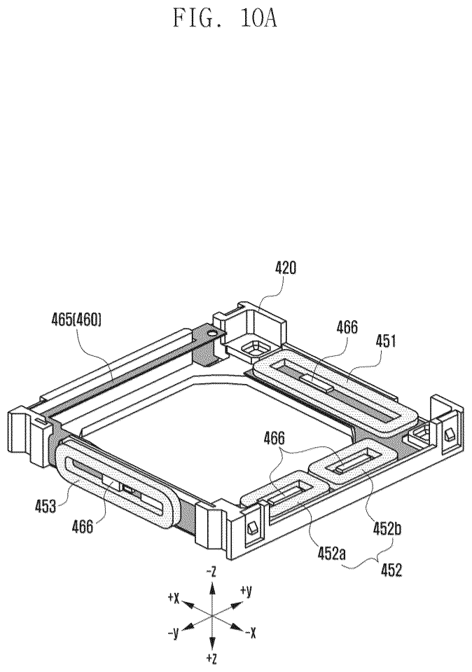

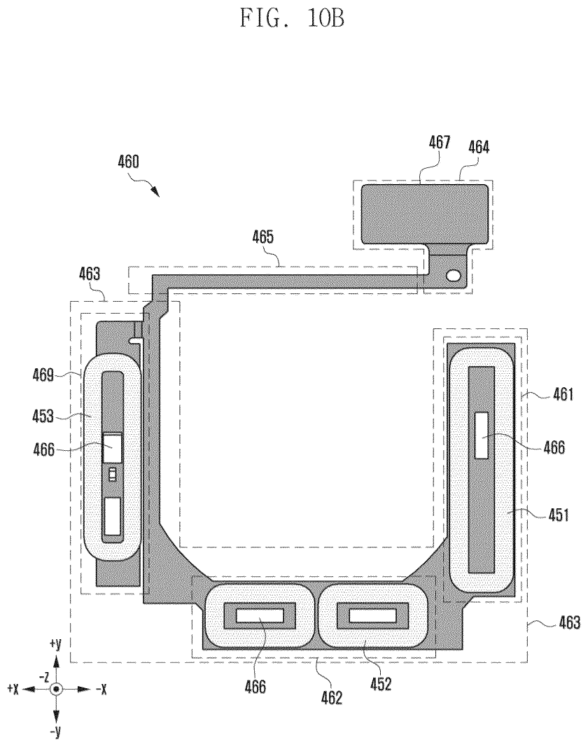

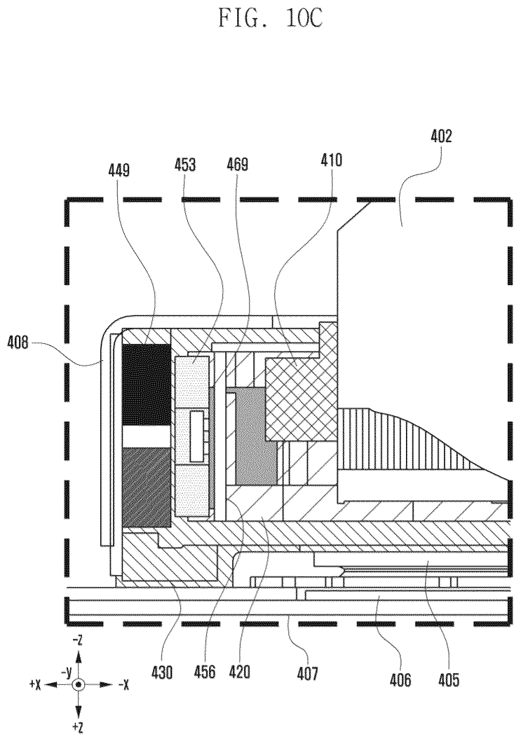

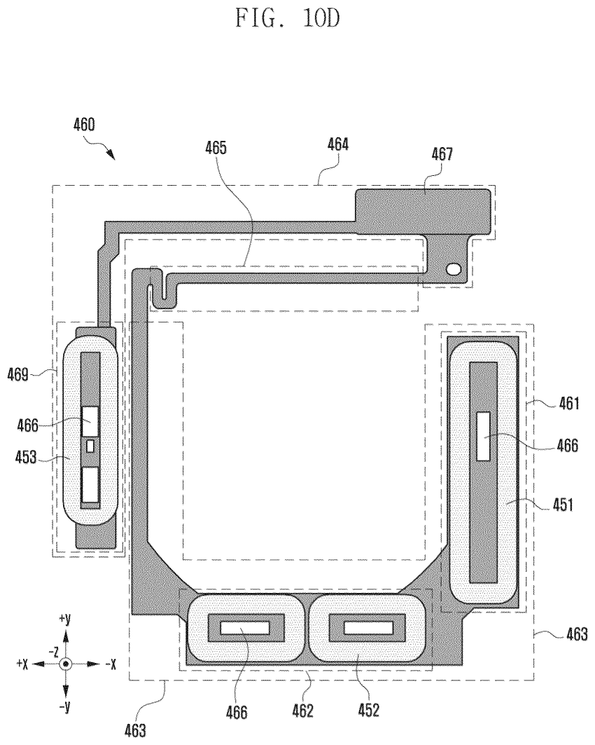

FIG. 10A is a perspective view illustrating the AF housing 420 according to various embodiments.

FIG. 10B is a plan view illustrating the coil circuit board 460 according to various embodiments

FIG. 10C is a cross-sectional view illustrating the camera 401 according to various embodiments.

FIG. 10D is a plan view illustrating the coil circuit board 460 according to various embodiments.

Referring to FIG. 10A, FIG. 10B, and FIG. 10C, a third coil (e.g., the third coil 453 of FIG. 4B) may be positioned in the AF housing 420 according to various embodiments. The third coil 453 may be disposed on one lateral surface (e.g., a lateral surface facing the X-axis direction or a lateral surface facing the Y-axis direction) of the AF housing 420. A third magnet (e.g., the third magnet 449 of FIG. 4B) may be positioned in the base housing 430. The third magnet 449 may be positioned on an inner surface (e.g., a lateral surface facing the X-axis direction or an inner lateral surface facing the Y-axis direction) of the base housing 430 facing the third coil 453.

In various embodiments, the coil circuit board 460 may include a third portion 469 in which the third coil 453 is positioned. The third portion 469 may be included in the first fixing part 463.

The third coil 453 for driving a focusing operation of the AF housing 420 is disposed on the same coil circuit board 460 as the first coil 451 and the second coil 452 for driving an OIS operation, and thus a separate circuit board for exciting and controlling the third coil 453 and a separate connector connected to the separate circuit board may be omitted. In addition, since a process for assembling them may be omitted, manufacturing cost and manufacturing lead time of the camera 401 may be reduced. In various embodiments, the third portion 469 may have at least a partial area formed to be bendable so that the third coil 453 is disposed in a plane (e.g., the y-z plane) substantially parallel to an optical axis. For example, the third portion 469 may include a flexible printed circuit board. Through the above configuration, the third magnet 449 generates an electromagnetic force (Lorentz force) on the third coil 453, and the third coil 453 is fixed to the AF housing 420, and thus the AF housing 420 may move for an AF operation. AF yoke 456 may be positioned in the AF housing 420 so as to be positioned in a direction opposite to a direction in which the third magnet 449 is positioned with respect to the third coil 453.

Referring to FIG. 10D, the third portion 469 in which the third coil 453 is disposed may be included in the second fixing part 464. Various embodiments may be possible in which the third magnet 449 is disposed in the AF housing 420 and the third coil 453 is disposed in the base housing 430. In such one or more embodiments, the third portion 469 in which the third coil 453 is disposed may be included in the second fixing part 464 fixed to the base housing 430. In this way, even in one or more embodiments in which the third magnet 449 is disposed in the AF housing 420, the above-described advantages of the first coil 451, the second coil 452, and the third coil 453 being all arranged on one coil circuit board 460 may be obtained. In various embodiments, the second fixing part 464 may have at least a partial area formed to be bendable so that the third coil 453 is disposed in a plane (e.g., the y-z plane) substantially parallel to the optical axis. For example, the second fixing part 464 may include a flexible printed circuit board. Through the above configuration, the third magnet 449 generates an electromagnetic force (Lorentz force) on the third coil 453, and the third magnet 449 disposed in the AF housing 420 moves due to a reaction force of the electromagnetic force, so that the AF housing 420 may perform the AF operation. The AF yoke 456 may be positioned in the base housing 430 so as to be positioned in a direction opposite to a direction in which the third magnet 449 is positioned with respect to the third coil 453.

In various embodiments, the second fixing part 464 may have at least a partial area formed to be bendable, so as to facilitate coupling of the connector 467 to another member. For example, the second fixing part 464 may include a flexible printed circuit board.

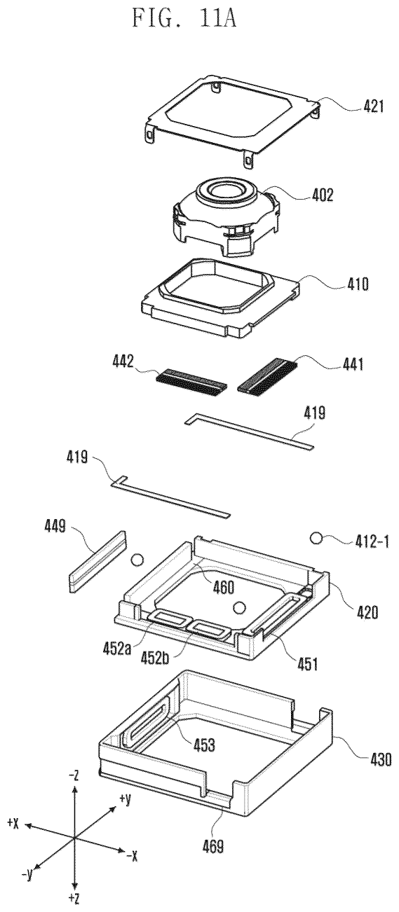

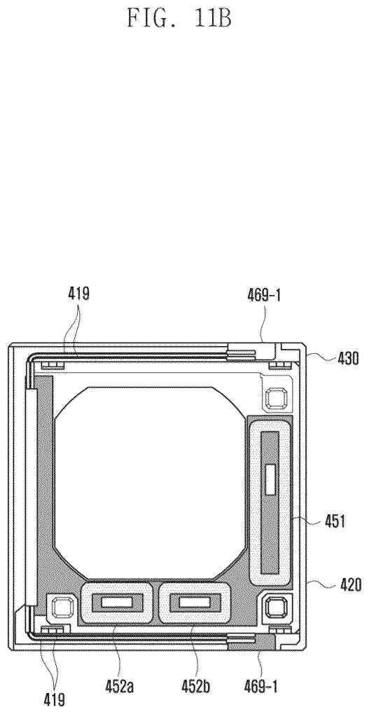

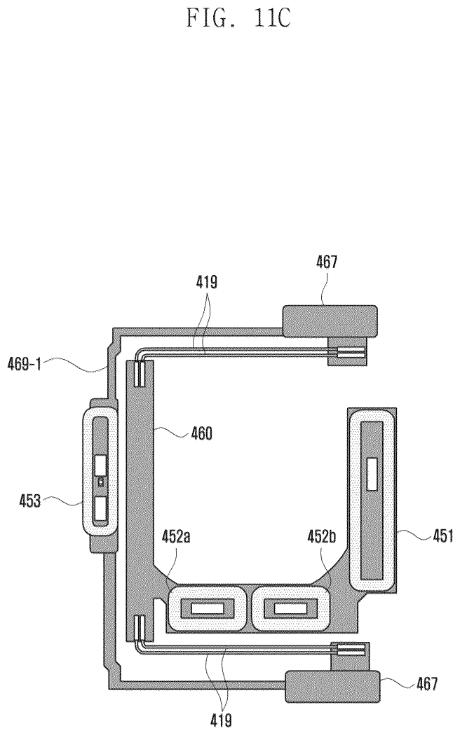

FIG. 11A is an exploded perspective view illustrating the camera 401 according to various embodiments.

FIG. 11B is a plan view illustrating the base housing 430 and the AF housing 420 of the camera 401 according to various embodiments.

FIG. 11C is a plan view illustrating the coil circuit board 460 and a fixed circuit board 469-1 according to various embodiments.

Referring to FIG. 11A and FIG. 11B, the camera 401 according to various embodiments may include an elastic connection member 419. The elastic connection member 419 may be a member which is fixed to each of the base housing 430 and the AF housing 420, and has elasticity to limit the direction of movement of the AF housing 420. In various embodiments, the elastic connection member 419 may be a member which is configured to be elastically deformed to limit other directions (e.g., a translational motion and/or a rotational motion in the x-axis and y-axis directions) of the AF housing 420 while allowing driving (e.g., a translational motion in the z-axis direction) for an AF operation of the AF housing 420. In various embodiments, the elastic connection member 419 may include a metal material (e.g., steel, stainless steel, and/or brass). In various embodiments, the elastic connection member 419 may perform at least a part of functions of an AF ball member (e.g., the AF ball member 412-2 of FIG. 4B) which guides the AF housing 420.

In various embodiments, the elastic connection member 419 may include a fixed circuit board 469-1 which is fixed to the base housing 430 and includes the connector 467 connected to the outside of the camera 401, and a plurality of OIS coils, first coil 451, (2-1)th coil 452a, and (2-2)th coil 452b, and may electrically connect the coil circuit board 460 fixed to the AF housing 420. For example, the elastic connection member 419 may be a member which performs a function of the flexible part 465 which interconnects the first fixing part 463 and the second fixing part 464 of FIG. 10B. The elastic connection member 419 performs both a guiding function of the AF housing 420 and a function of connecting the coil circuit board 460 to the outside, and thus the reliability of the camera 401 can be improved and manufacturing cost can be reduced.

An electronic device may move an optical system for optical image stabilization. The optical system may be moved by a magnetic force between a coil and a magnet. The amount of movement of the optical system may be measured by a magnetic sensor (e.g., a Hall effect sensor). When the coil acts as an electromagnet to apply a force to push a magnetic pole of the magnet in the direction of a magnetic axis, the magnetic force generated between the magnet and the coil may become nonlinearly weaker as the magnet moves farther away. Therefore, there is a problem in which a driving force weakens as the amount of shake compensation due to optical stabilization increases. In addition, since a measurement signal of the magnetic sensor also changes nonlinearly according to the amount of movement of the optical system, there is a limitation in accurately controlling the movement of the optical system based on the magnetic sensor.

According to various embodiments of the disclosure, a camera which performs optical image stabilization with an improved driving force and controllability may be provided.

The technical tasks to be achieved in the disclosure may not be limited to the above-mentioned technical tasks, and other technical tasks not mentioned may be clearly understood by those skilled in the art to which the disclosure belongs.

An electronic device according to various embodiments of the disclosure may be an electronic device including a camera 401. The camera 401 may include an optical system 402 having an optical axis, and an image sensor 406 disposed to be at least partially aligned with the optical axis of the optical system 402. The camera 401 may include a base housing 430 which at least partially surrounds the image sensor 406. The camera 401 may include an autofocus (AF) housing 420 at least partially received in the base housing 430 so as to be movable along a direction of the optical axis. The camera 401 may include a coil circuit board 460 at least partially disposed on a bottom surface of the AF housing 420 and including a first coil and a second coil 452 oriented so that a magnetic axis 450a faces the same direction as the optical axis. The camera 401 may include an optical image stabilization (OIS) housing in which the optical system 402 is disposed and which is at least partially received in the AF housing 420. The OIS housing 410 may include a first magnet 441 facing the first coil and a second magnet 442 facing the second coil 452. The OIS housing 410 may be configured to be movable in a first direction substantially perpendicular to the optical axis and a second direction substantially perpendicular to the optical axis and the first direction by using the first coil, the second coil, the first magnet, and the second magnet.

In various embodiments, the first magnet 441 and the second magnet 442 may be arranged on a first surface of the OIS housing 410 substantially parallel to the bottom surface of the AF housing 420. The OIS housing 410 may be at least partially disposed within the AF housing 420 such that a distance between the bottom surface of the AF housing 420 and the first surface is substantially constant when moved in the first direction and the second direction.

In various embodiments, the first magnet 441 may be a single-sided two-pole magnet.

In various embodiments, the coil circuit board 460 may include a first portion 461 disposed on the bottom surface of the AF housing 420 and a second portion 462 substantially perpendicular to the first portion 461, the first coil 451 may be disposed in the first portion 461, and the second coil 452 may be disposed in the second portion 462.

In various embodiments, the camera 401 may further include a guide member 415 disposed within the AF housing 420 so as to limit a rotational movement of the OIS housing 410 around the direction of the optical axis as a rotation axis, while allowing a movement of the OIS housing 410 in the first direction and the second direction.

In various embodiments, the second coil 452 may include a (2-1)th coil 452a and a (2-2)th coil 452b which are arranged substantially parallel to each other.

In various embodiments, the coil circuit board 460 may include a first fixing part 463 fixed to the AF housing 420. The coil circuit board 460 may include a second fixing part 464 fixed to the base housing 430. The coil circuit board 460 may include a flexible part 465 positioned between the first fixing part 463 and the second fixing part 464, and having flexibility.

In various embodiments, a length of the flexible part 465 may be longer than a distance between an area of the AF housing 420 to which the first fixing part 463 is fixed and an area of the base housing 430 to which the second fixing part 464 is fixed.

In various embodiments, the flexible part 465 may be received in the AF housing 420 while at least a part thereof is bent.

In various embodiments, at least a partial area of the coil circuit board 460 may be positioned between an outer surface of the OIS housing 410 and an inner surface of the AF housing 420. The OIS housing 410 may include a stopper 411 protruding in at least one of the first direction or the second direction from the outer surface of the OIS housing 410. A length of the stopper 411 protruding from the outer surface of the OIS housing 410 may be equal to or greater than a width of the coil circuit board 460 positioned between the outer surface of the OIS housing 410 and the inner surface of the AF housing 420.

In various embodiments, the camera 401 may further include a third coil 453 disposed on an inner surface of the base housing 430. The camera 401 may further include a third magnet 449 disposed in the AF housing 420 so as to face the third coil 453, and having a magnetic pole oriented to apply a magnetic force in the direction of the optical axis with respect to the third coil 453.

In various embodiments, the camera 401 may include a third magnet 449 disposed on an inner surface of the base housing 430 and a third coil 453 disposed in the AF housing 420 so as to face the third magnet 449. The third magnet 449 may have a magnetic pole oriented to apply a magnetic force in the direction of the optical axis with respect to the third coil 453, and the coil circuit board 460 may include a third portion in which the third coil 453 is disposed.

A camera 401 according to various embodiments of the disclosure may include an optical system 402 having an optical axis, and an image sensor 406 disposed to be at least partially aligned with the optical axis of the optical system 402. The camera 401 may include a base housing 430 which at least partially surrounds the image sensor 406. The camera 401 may include an autofocus (AF) housing 420 at least partially received in the base housing 430 so as to be movable along a direction of the optical axis. The camera 401 may include a coil circuit board 460 at least partially disposed on a bottom surface of the AF housing 420 and including a first coil and a second coil 452 oriented so that a magnetic axis 450a faces the same direction as the optical axis. The camera 401 may include an optical image stabilization (OIS) housing in which the optical system 402 is disposed and which is at least partially received in the AF housing 420. The OIS housing 410 may include a first magnet 441 facing the first coil and a second magnet 442 facing the second coil 452, and may be configured to be movable in a first direction substantially perpendicular to the optical axis and a second direction substantially perpendicular to the optical axis and the first direction by using the first coil, the second coil, the first magnet, and the second magnet.

In various embodiments, the first magnet 441 and the second magnet 442 may be disposed on a first surface of the OIS housing 410 substantially parallel to the bottom surface of the AF housing 420, and the OIS housing 410 may be at least partially disposed within the AF housing 420 such that a distance between the bottom surface of the AF housing 420 and the first surface is substantially constant when moved in the first direction and the second direction.

In various embodiments, the coil circuit board 460 may include a first portion 461 disposed on the bottom surface of the AF housing 420 and a second portion 462 substantially perpendicular to the first portion 461, the first coil 451 may be disposed in the first portion 461, and the second coil 452 may be disposed in the second portion 462.

In various embodiments, the camera 401 may further include a guide member 415 disposed within the AF housing 420 so as to limit a rotational movement of the OIS housing 410 around the direction of the optical axis as a rotation axis, while allowing a movement of the OIS housing 410 in the first direction and the second direction.

In various embodiments, the second coil 452 may include a (2-1)th coil 452a and a (2-2)th coil 452b which are arranged substantially parallel to each other.

In various embodiments, the coil circuit board 460 may include a first fixing part 463 fixed to the AF housing 420, a second fixing part 464 fixed to the base housing 430, and a flexible part 465 positioned between the first fixing part 463 and the second fixing part 464 and having flexibility, and a length of the flexible part 465 may be longer than a distance between an area of the AF housing 420 to which the first fixing part 463 is fixed and an area of the base housing 430 to which the second fixing part 464 is fixed.

In various embodiments, at least a partial area of the coil circuit board 460 may be positioned between an outer surface of the OIS housing 410 and an inner surface of the AF housing 420, the OIS housing 410 may include a stopper 411 protruding in at least one of the first direction or the second direction from the outer surface of the OIS housing 410, and a length of the stopper 411 protruding from the outer surface of the OIS housing 410 may be equal to or greater than a width of the coil circuit board 460 positioned between the outer surface of the OIS housing 410 and the inner surface of the AF housing 420.

In various embodiments, the camera 401 may include a third coil 453 disposed on the inner surface of the base housing 430, and a third magnet 449 disposed in the AF housing 420 so as to face the third coil 453, and having a magnetic pole oriented to apply a magnetic force in the direction of the optical axis with respect to the third coil 453.

According to various embodiments of the disclosure, since a magnetic axis of an OIS driving coil faces the direction of the optical axis, and a magnetic pole of an OIS driving magnet is oriented to generate an electromagnetic force (e.g., Lorentz force) in a direction perpendicular to a direction facing the OIS driving coil, a distance between the coil and the magnet is maintained substantially constant during OIS driving, so that a change in a driving force of the coil due to a change in the distance is reduced, and the position control of the magnet through a magnetic sensor may be facilitated. In addition, since a change in a driving force between the coil and the magnet is reduced, sufficient OIS control force can be secured even when a driving current of the OIS coil is low and/or a magnetic force of the OIS driving magnet is weak. In addition, by increasing the size of the OIS driving magnet in a direction perpendicular to the optical axis (e.g., in the X-Y plane), an OIS driving distance may be increased, and thus the thickness of a camera unit can be minimized while securing a high OIS correction range.

The effects obtainable from the disclosure are not limited to the above-mentioned effects, and other effects not mentioned may be clearly understood by those skilled in the art to which the disclosure belongs.

In addition, the embodiments disclosed in this document disclosed in the specification and drawings are provided only to provide a specific example in order to easily describe the technical content according to the embodiment disclosed in this document and to help understanding of the embodiment disclosed in this document, and are not intended to limit the scope of the embodiment disclosed in this document. Therefore, the scope of various embodiments disclosed in this document should be interpreted to include all changes or modified forms derived based on the technical spirit of various embodiments disclosed in this document in addition to the embodiments disclosed herein.

What is claimed is:

1. An electronic device comprising a camera, the camera comprising:
an optical system comprising an optical axis;
an image sensor that is at least partially aligned with the optical axis of the optical system;
a base housing which is at least partially surrounding the image sensor;
an autofocus (AF) housing at least partially arranged in the base housing and configured to be movable along a direction of the optical axis;
a coil circuit board at least partially disposed on a bottom surface of the AF housing and comprising a first coil and a second coil oriented with a magnetic axis facing a direction identical to that of the optical axis; and
an optical image stabilization (OIS) housing in which the optical system is disposed and which is at least partially received in the AF housing,
wherein the OIS housing comprises a first magnet, facing the first coil, and a second magnet, facing the second coil, and is configured to be movable in a first direction, substantially perpendicular to the optical axis, and a second direction, substantially perpendicular to both of the optical axis and the first direction, by the first coil, the second coil, the first magnet, and the second magnet.

2. The electronic device of claim 1, wherein the first magnet and the second magnet are arranged on a first surface of the OIS housing substantially parallel to the bottom surface of the AF housing, and
wherein the OIS housing is at least partially disposed within the AF housing and a distance between the bottom surface of the AF housing and the first surface is substantially constant when moved in any of the first direction and the second direction.

3. The electronic device of claim 1, wherein the first magnet is a single-sided two-pole magnet.

4. The electronic device of claim 1, wherein the coil circuit board comprises a first portion, disposed on the bottom surface of the AF housing, and a second portion substantially perpendicular to the first portion, and
wherein the first coil is disposed in the first portion, and the second coil is disposed in the second portion.

5. The electronic device of claim 1, wherein the camera further comprises a guide member disposed within the AF housing and configured both to limit a rotational movement of the OIS housing, around the direction of the optical axis as a rotation axis, and to allow a movement of the OIS housing in the first direction and the second direction.

6. The electronic device of claim 1, wherein the second coil comprises a (2-1)th coil and a (2-2)th coil which are arranged substantially parallel to each other.

7. The electronic device of claim 1, wherein the coil circuit board comprises:
a first fixing part fixed to the AF housing;
a second fixing part fixed to the base housing; and
a flexible part positioned between the first fixing part and the second fixing part and comprising a flexibility greater than that of the first fixing part and the second fixing part.

8. The electronic device of claim 7, wherein a length of the flexible part is longer than a distance between an area of the AF housing to which the first fixing part is fixed and an area of the base housing to which the second fixing part is fixed.

9. The electronic device of claim 8, wherein the AF housing is configured to receive the flexible part in the AF housing while at least a part of the flexible part is bent.

10. The electronic device of claim 1, wherein at least a partial area of the coil circuit board is positioned between an outer surface of the OIS housing and an inner surface of the AF housing,
wherein the OIS housing comprises a stopper protruded in at least one of the first direction or the second direction from the outer surface of the OIS housing, and
wherein a length of the stopper protruded from the outer surface of the OIS housing is equal to or greater than a width of the coil circuit board positioned between the outer surface of the OIS housing and the inner surface of the AF housing.

11. The electronic device of claim 1, wherein the camera further comprises:
a third coil disposed on an inner surface of the base housing; and
a third magnet disposed in the AF housing, facing the third coil, and comprising a magnetic pole applying a magnetic force in the direction of the optical axis with respect to the third coil.

12. The electronic device of claim 1, wherein the camera further comprises:
a third magnet disposed on an inner surface of the base housing; and
a third coil disposed in the AF housing and facing the third magnet,
wherein the third magnet comprises a magnetic pole applying a magnetic force in the direction of the optical axis with respect to the third coil, and
wherein the coil circuit board comprises a third portion in which the third coil is disposed.

13. A camera comprising:
an optical system comprising an optical axis;
an image sensor that is at least partially aligned with the optical axis of the optical system;
a base housing which is at least partially surrounding the image sensor;
an autofocus (AF) housing at least partially arranged in the base housing and configured to be movable along a direction of the optical axis;
a coil circuit board at least partially disposed on a bottom surface of the AF housing and comprising a first coil and a second coil oriented with a magnetic axis facing a direction identical to that of the optical axis; and
an optical image stabilization (OIS) housing in which the optical system is disposed and which is at least partially received in the AF housing,
wherein the OIS housing comprises a first magnet facing the first coil and a second magnet facing the second coil, and is configured to be movable in a first direction, substantially perpendicular to the optical axis, and a second direction, substantially perpendicular to both of the optical axis and the first direction, by the first coil, the second coil, the first magnet, and the second magnet.

14. The camera of claim 13, wherein the first magnet and the second magnet are arranged on a first surface of the OIS housing substantially parallel to the bottom surface of the AF housing, and
wherein the OIS housing is at least partially disposed within the AF housing and a distance between the bottom surface of the AF housing and the first surface is substantially constant when moved in any of the first direction and the second direction.

15. The camera of claim 13, wherein the coil circuit board comprises a first portion, disposed on the bottom surface of the AF housing, and a second portion substantially perpendicular to the first portion, and
wherein the first coil is disposed in the first portion, and the second coil is disposed in the second portion.

16. The camera of claim 13, further comprising a guide member disposed within the AF housing and configured both to limit a rotational movement of the OIS housing, around the direction of the optical axis as a rotation axis, and to allow a movement of the OIS housing in the first direction and the second direction.

17. The camera of claim 13, wherein the second coil comprises a (2-1)th coil and a (2-2)th coil which are arranged substantially parallel to each other.

18. The camera of claim 13, wherein the coil circuit board comprises:
a first fixing part fixed to the AF housing;
a second fixing part fixed to the base housing; and
a flexible part positioned between the first fixing part and the second fixing part and comprising a flexibility greater than that of the first fixing part and the second fixing part, and
wherein a length of the flexible part is longer than a distance between an area of the AF housing to which the first fixing part is fixed and an area of the base housing to which the second fixing part is fixed.

19. The camera of claim 13, wherein at least a partial area of the coil circuit board is positioned between an outer surface of the OIS housing and an inner surface of the AF housing,
wherein the OIS housing comprises a stopper protruded in at least one of the first direction or the second direction from the outer surface of the OIS housing, and
wherein a length of the stopper protruded from the outer surface of the OIS housing is equal to or greater than a width of the coil circuit board positioned between the outer surface of the OIS housing and the inner surface of the AF housing.

20. The camera of claim 13, comprising:
a third coil disposed on an inner surface of the base housing; and
a third magnet disposed in the AF housing, facing the third coil, and comprising a magnetic pole applying a magnetic force in the direction of the optical axis with respect to the third coil.
